(19) United States
(12) Patent Application Publication
(10) Pub. No.: US 2018/0089166 A1
(43) Pub. Date: Mar. 29, 2018

(54) USER INTERFACE FOR PROVIDING TEXT PREDICTION

(71) Applicant: Apple Inc., Cupertino, CA (US)

(72) Inventors: Adam S. MEYER, Cupertino, CA (US); Wayne C. WESTERMAN, Burlingame, CA (US)

(21) Appl. No.: 15/423,290

(22) Filed: Feb. 2, 2017

Related U.S. Application Data
(60) Provisional application No. 62/399,021, filed on Sep. 23, 2016.

(51) Int. Cl. G06F 17/27; G06F 3/0488; G06F 3/01

(52) U.S. Cl. CPC G06F 17/276; G06F 3/04883; G06F 3/016; G06F 3/04886

(57) ABSTRACT

The present disclosure generally relates to providing text prediction. In one example process, a keyboard comprising a plurality of keys is provided. Each key of the plurality of keys is configured to register a respective character of a symbolic system on a displayed user interface. User input corresponding to one or more words is received via the keyboard. The process determines a plurality of candidate predicted words based on the one or more words. A candidate predicted word of the plurality of candidate predicted words is displayed on a key of the plurality of keys, where the key is configured to register a character of the symbolic system on the user interface. The candidate predicted word begins with the character of the symbolic system.

### CROSS-REFERENCE TO RELATED APPLICATIONS

This application relates to U.S. Provisional Ser. No. 62/399,021, filed on Sep. 23, 2016, entitled USER INTERFACE FOR PROVIDING TEXT PREDICTION, which is hereby incorporated by reference in its entirety for all purposes.

### FIELD

The present disclosure relates generally to text prediction, and more specifically, to user interfaces for providing text prediction.

### BACKGROUND

In many modern day electronic devices, typing and text input can be tedious. For example, mobile devices can have smaller virtual keyboards that are slow and inaccurate for inputting text. Additionally, virtual keyboards can generally lack tactile feedback to guide the user, which can reduce the speed and accuracy at which the user inputs text. In order to improve the speed and accuracy of text input, text prediction systems can be implemented in electronic devices. These text prediction systems can detect the words inputted into the device and predict a set of candidate next words based upon the input text. One or more candidate predicted words can then be presented to the user for selection. However, conventional interfaces for providing text prediction can be cumbersome and non-intuitive, where selection of a desired candidate predicted word can actually require more time than manually typing out the same word.

### BRIEF SUMMARY

Systems, processes, and user interfaces for providing text prediction are described herein. In one example process, a keyboard comprising a plurality of keys is provided. Each key of the plurality of keys is configured to register a respective character of a symbolic system on a displayed user interface. User input corresponding to one or more words is received via the keyboard. The process determines a plurality of candidate predicted words based on the one or more words. A candidate predicted word of the plurality of candidate predicted words is displayed on a key of the plurality of keys, where the key is configured to register a character of the symbolic system on the user interface. The candidate predicted word begins with the character of the symbolic system.

In another example process, a keyboard comprising a plurality of keys is provided. Each key of the plurality of keys is configured to register a respective character of a symbolic system on a displayed user interface. User input corresponding to text is received via the keyboard. The process determines a plurality of candidate predicted words based on the text. A candidate predicted word of the plurality of candidate predicted words is displayed on a key of the plurality of keys, where the key is configured to register a character of the symbolic system on the user interface. At least a portion of the text corresponds to a first portion of the candidate predicted word, and a second portion of the candidate predicted word begins with the character of the symbolic system.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 6 illustrates an exemplary block diagram of a text prediction module in accordance with some embodiments.

FIGS. 7A-7D illustrate a flow diagram of an exemplary process for providing text prediction in accordance with some embodiments.

FIG. 8 illustrates an electronic device displaying an exemplary user interface for providing text prediction.

FIGS. 9A-9M illustrate an electronic device displaying exemplary user interfaces for providing text prediction in accordance with some embodiments.

FIG. 10 illustrates a functional block diagram of an exemplary electronic device in accordance with some embodiments.

### DESCRIPTION OF EMBODIMENTS

The following description sets forth exemplary methods, parameters, and the like. It should be recognized, however, that such description is not intended as a limitation on the scope of the present disclosure, but is instead provided as a description of exemplary embodiments.

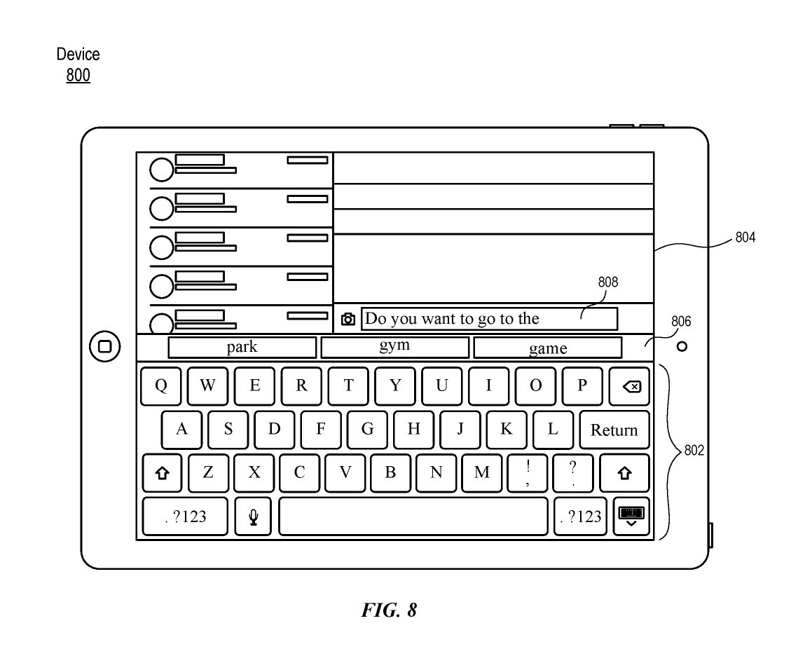

As discussed above, conventional interfaces for providing text prediction can be cumbersome and non-intuitive. In some cases, the use of such text prediction interfaces can actually reduce the speed, accuracy, and efficiency at which a user inputs text. For example, FIG. 8 illustrates electronic device 800 displaying an exemplary user interface for providing text prediction. In this example, text prediction interface 806 is displayed above keyboard 802 on touchscreen 804. As shown, text prediction interface 806 presents candidate predicted words (e.g., “park,” “gym,” and “game”) in respective user interface elements for the user to select. The candidate predicted words are based on the text input in user interface 808 (e.g., “Do you want to go to the”). Selection of a user interface element causes the corresponding candidate predicted word to be displayed in user interface 808. In this example, in order for a user to utilize the text prediction features of text prediction interface 806, the user would need to shift his/her eyes away from keyboard 802 during typing and monitor the candidate predicted words being presented in text prediction interface 806. For soft keyboards (e.g., keyboard 802), which lack tactile feedback to guide the user during typing, the shifting of attention away from the keyboard can reduce typing speed and accuracy. Additionally, if the user identifies a desired candidate predicted word displayed in text prediction interface 806, the user would need to significantly alter his/her hand position to reach above keyboard 802 and select a desired candidate predicted word. Such an action can be particularly cumbersome for larger touchscreen devices (e.g., tablets, etc.), where the user would need to reach across a larger distance to select the desired candidate predicted word. The user would thus require more time to return to an efficient typing position on keyboard 802. As a result, utilizing such text prediction interfaces can reduce the speed, accuracy, and efficiency of text input. Accordingly, a more effective system, process, and user interface for providing text prediction is desired.

In accordance with at least some embodiments of the present disclosure, systems processes, and user interfaces for providing text prediction are described. As described in greater detail below, the text prediction functionalities are integrated with the keyboard interface such that candidate predicted words are displayed on the subsequent keys that would typically be selected to manually type out the respective candidate predicted words. This enables the user to monitor and select candidate predicted words without needing to divert his/her attention away from the keyboard or significantly shifting his/her fingers from the optimal typing position. The user can thus input text using text prediction functionalities with greater speed, accuracy, and efficiency. In one example process, a keyboard comprising a plurality of keys is provided. Each key of the plurality of keys is configured to register a respective character of a symbolic system on a displayed user interface. User input corresponding to one or more words is received via the keyboard. The process determines a plurality of candidate predicted words based on the one or more words. A candidate predicted word of the plurality of candidate predicted words is displayed on a key of the plurality of keys, where the key is configured to register a character of the symbolic system on the user interface. The candidate predicted word begins with the character of the symbolic system.

In another example process, a keyboard comprising a plurality of keys is provided. Each key of the plurality of keys is configured to register a respective character of a symbolic system on a displayed user interface. User input corresponding to text is received via the keyboard. The process determines a plurality of candidate predicted words based on the text. A candidate predicted word of the plurality of candidate predicted words is displayed on a key of the plurality of keys, where the key is configured to register a character of the symbolic system on the user interface. At least a portion of the text corresponds to a first portion of the candidate predicted word, and a second portion of the candidate predicted word begins with the character of the symbolic system.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described embodiments. The first input and the second input are both inputs, but they may not be the same input.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

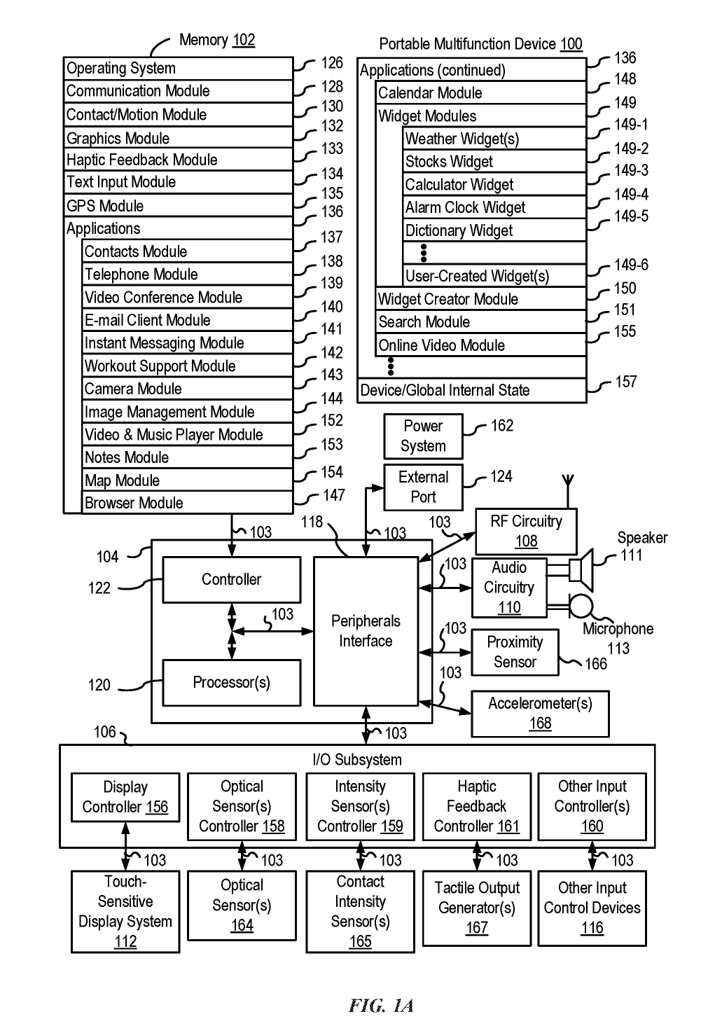

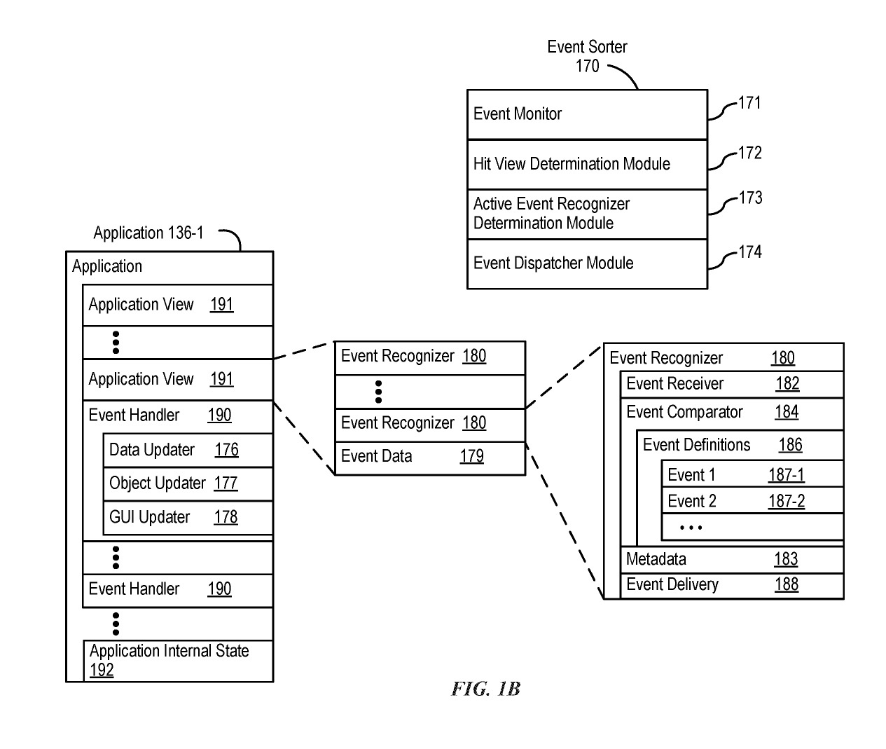

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

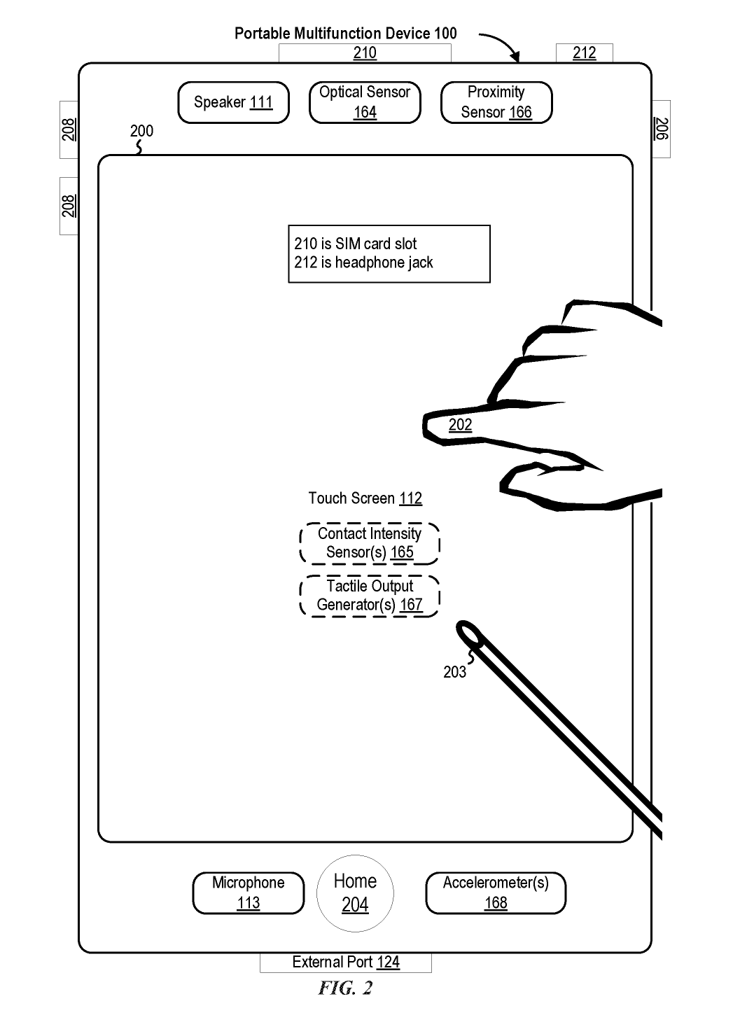

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

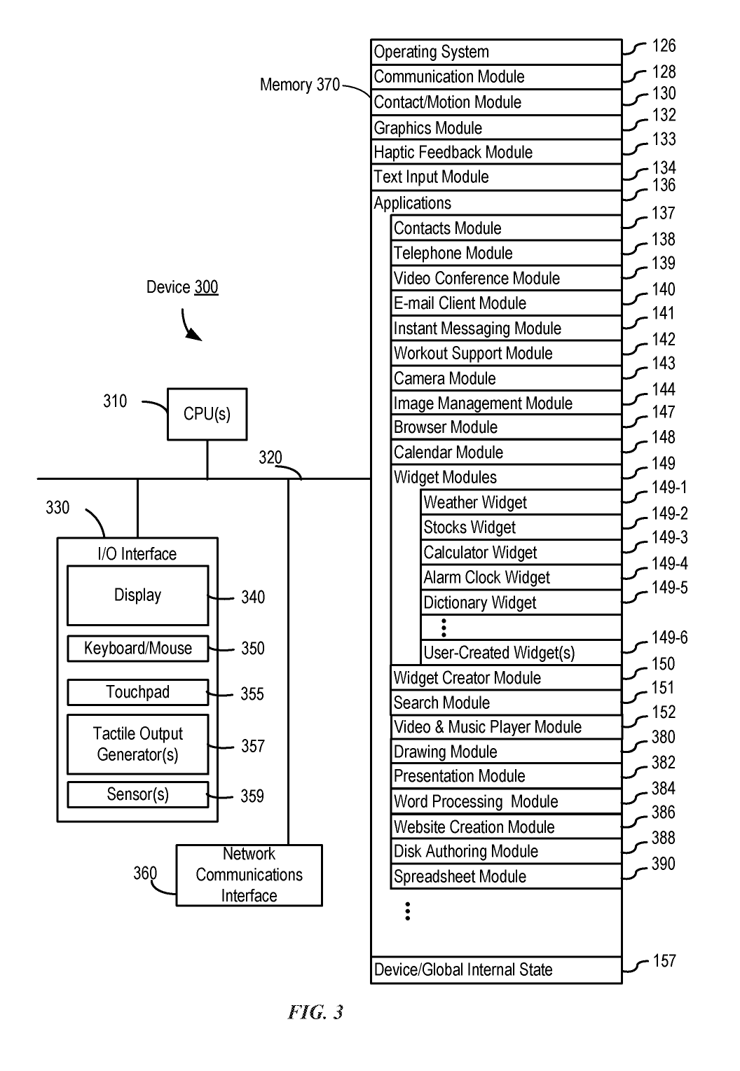

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

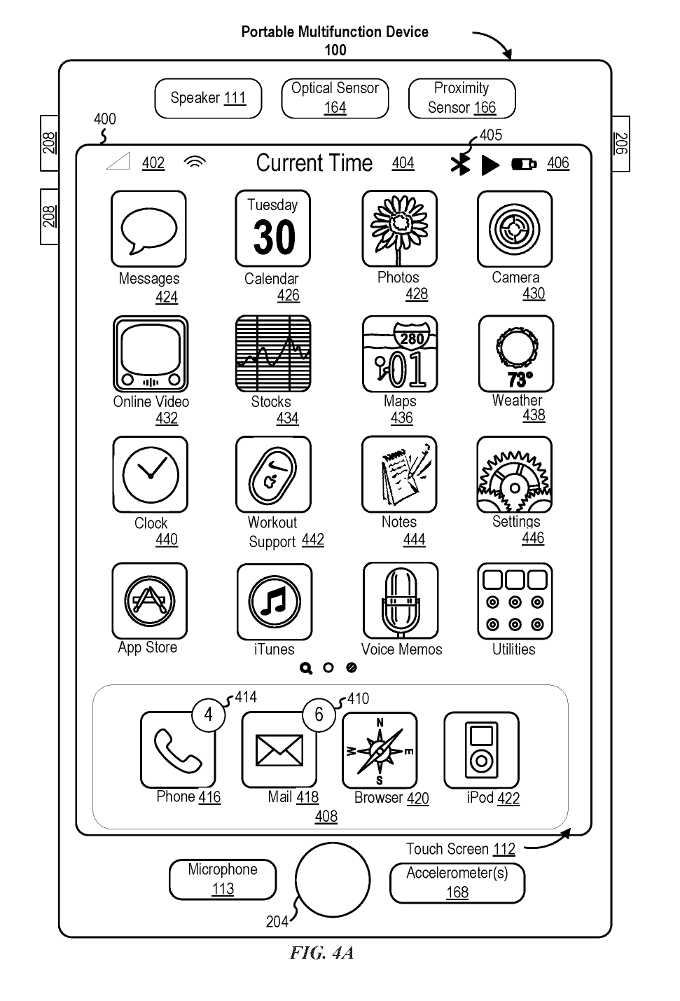

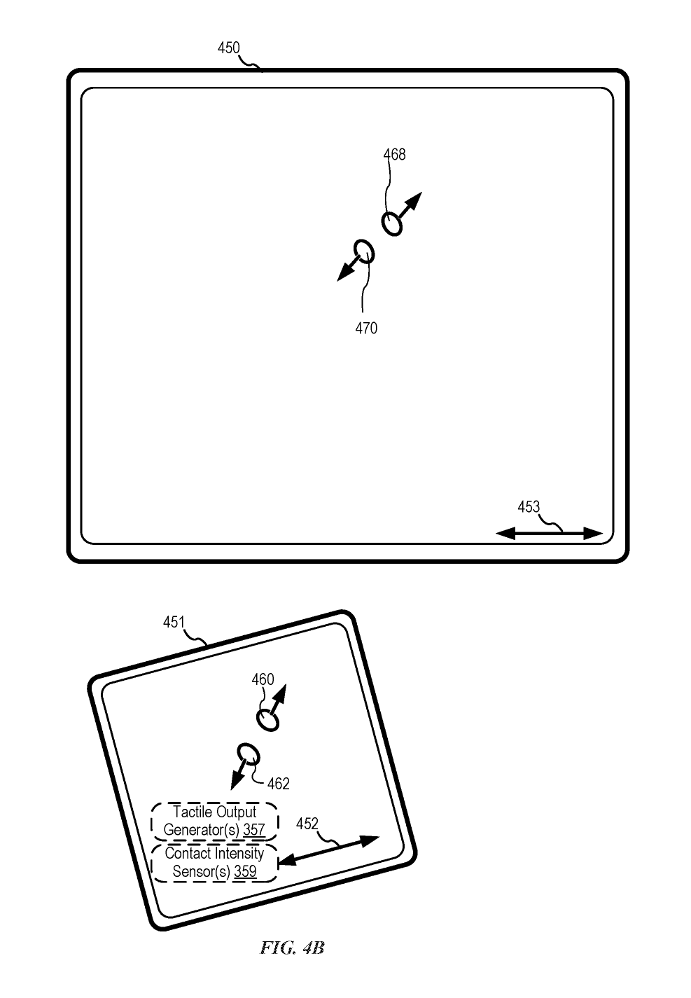

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 are labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

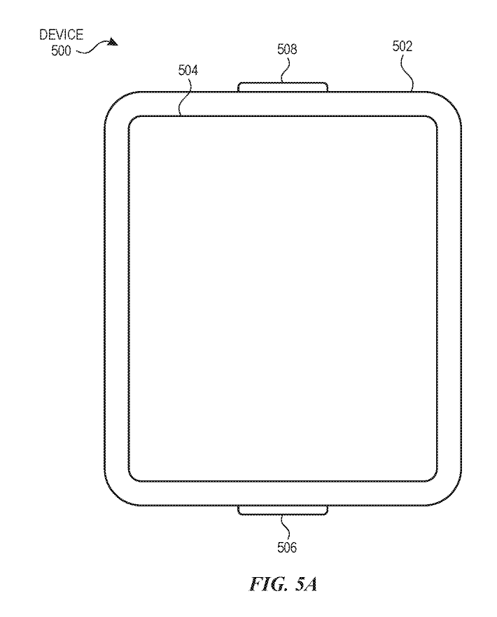

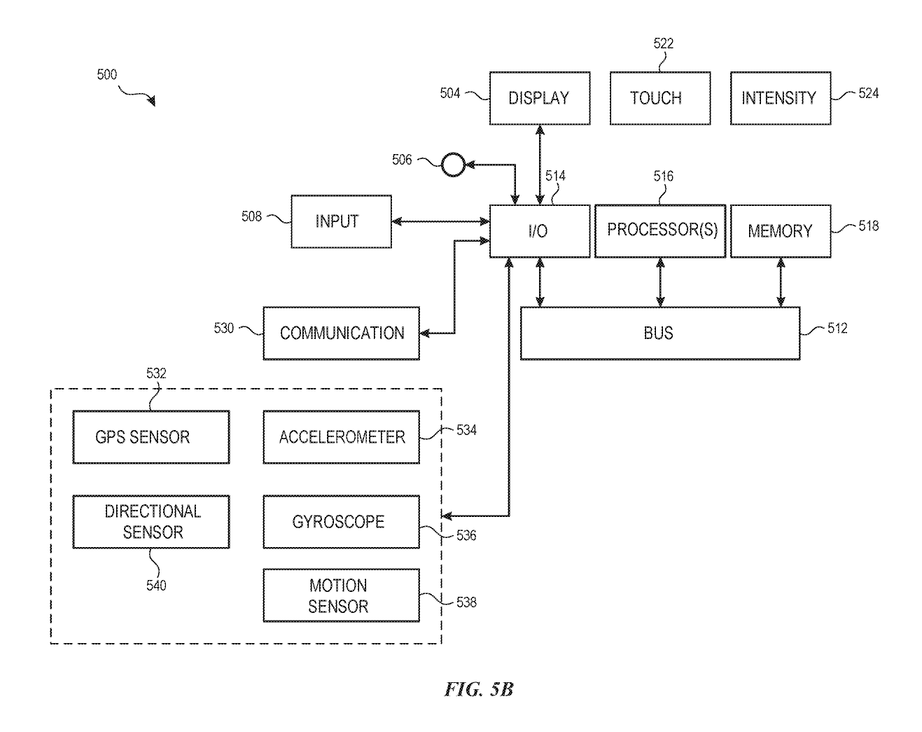

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including the processes described below. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1, 3, and 5). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

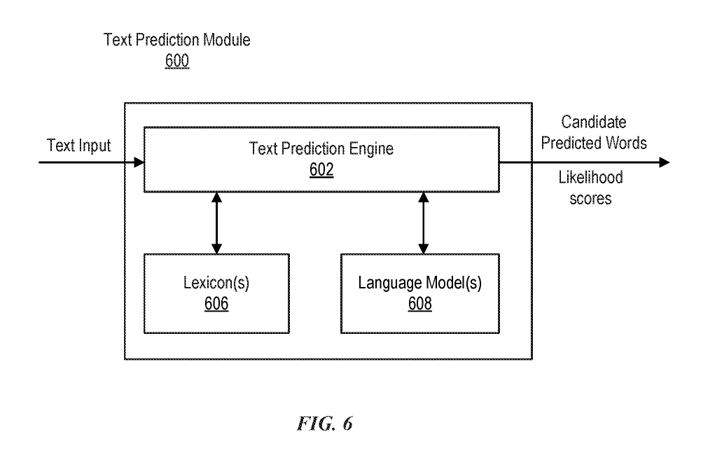

FIG. 6 illustrates an exemplary schematic block diagram of text prediction module 600 in accordance with some embodiments. In some embodiments, text prediction module 600 is implemented using one or more multifunction devices including, but not limited to, devices 100, 300, 900, and 1000 (FIGS. 1A, 3, and 10). In some examples, memory 102 (FIG. 1A) or 370 (FIG. 3) includes text prediction module 600. Text prediction module 600, in some examples, corresponds to a set of instructions for performing the various text prediction functionalities described below in process 700. It should be recognized that language prediction module 600 need not be implemented as a separate software program, procedure, or module, and thus, various subsets of the module are, optionally, combined or otherwise rearranged in various embodiments.

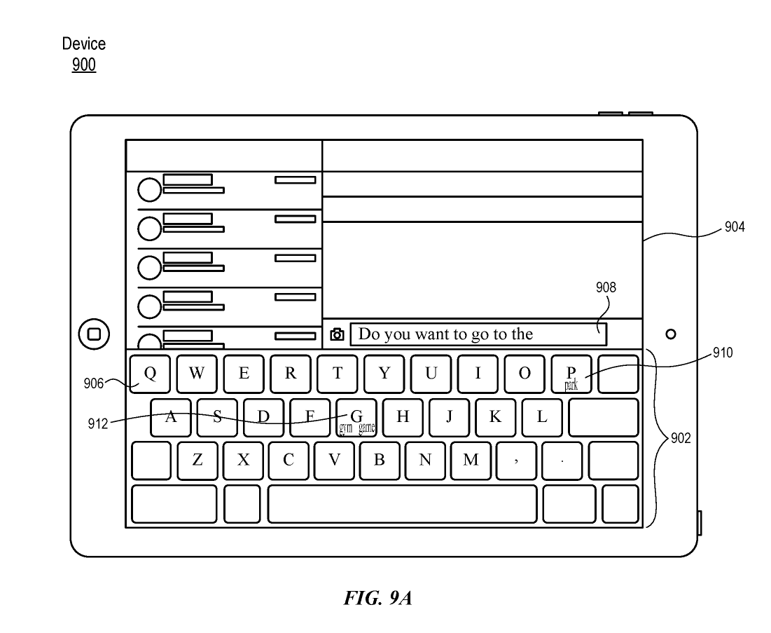

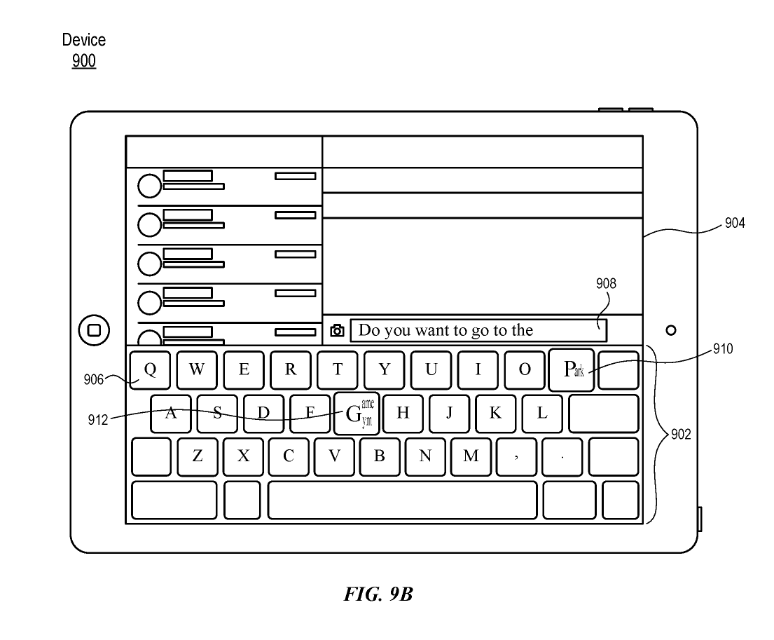

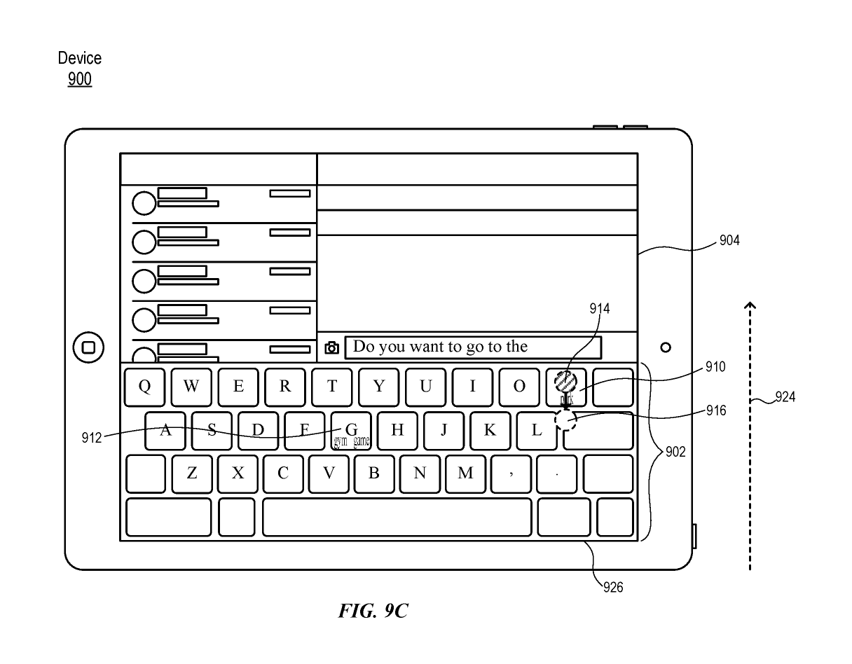

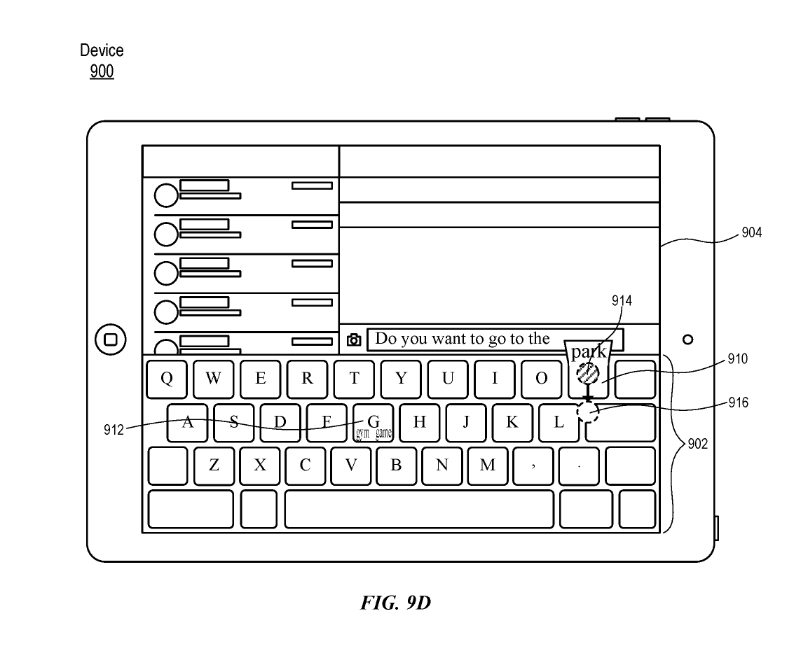

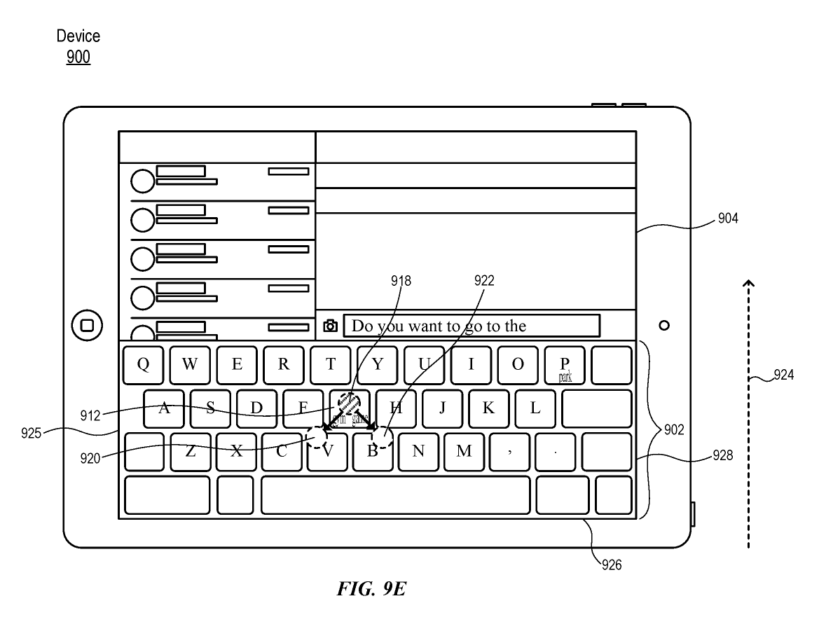

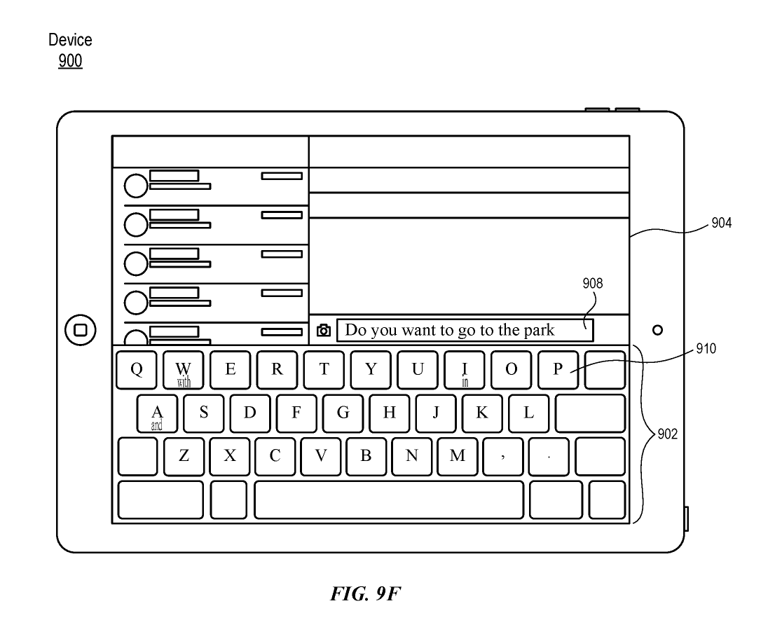

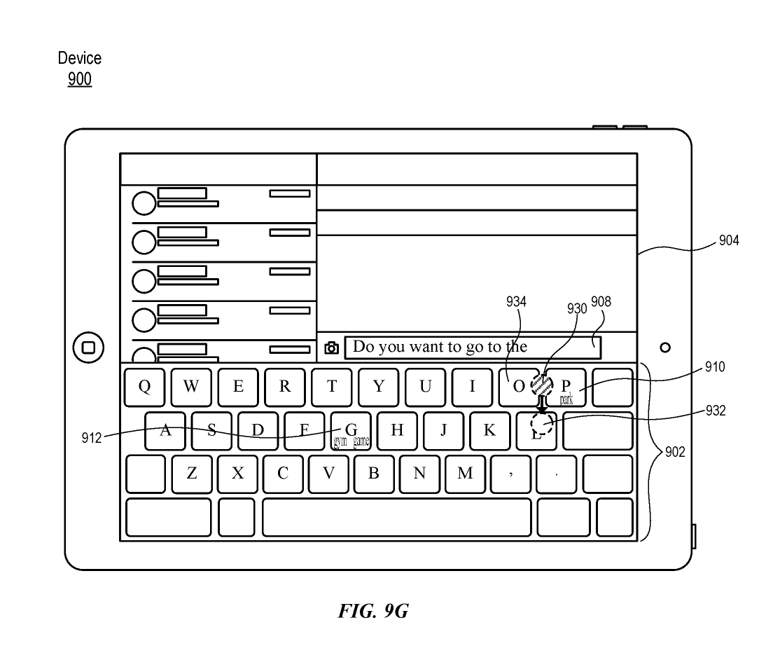

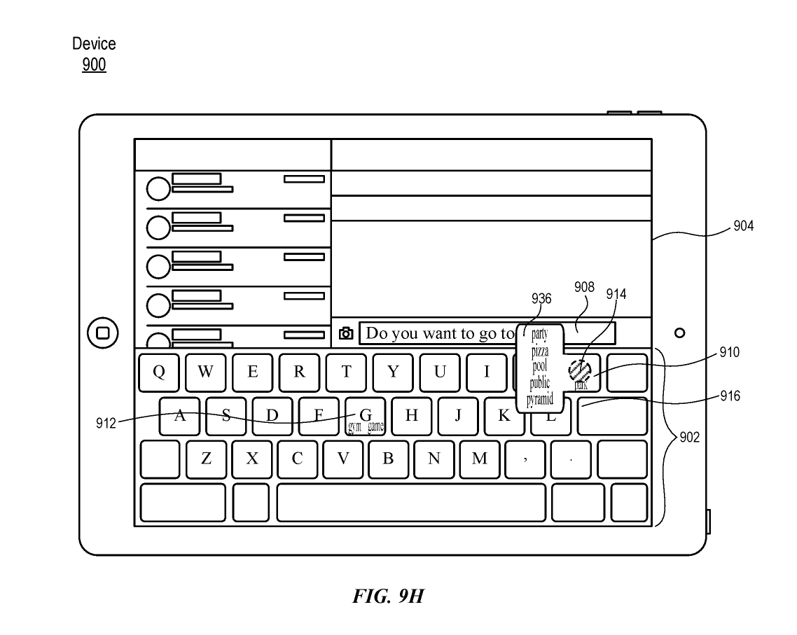

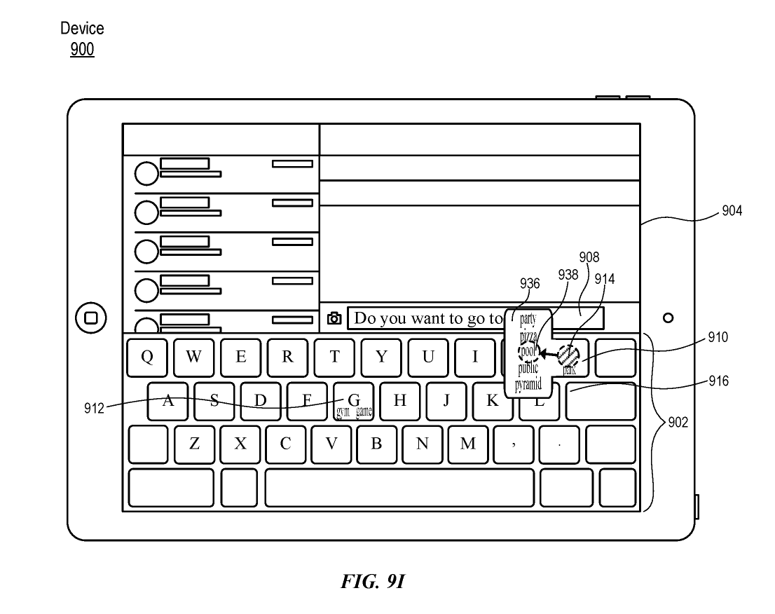

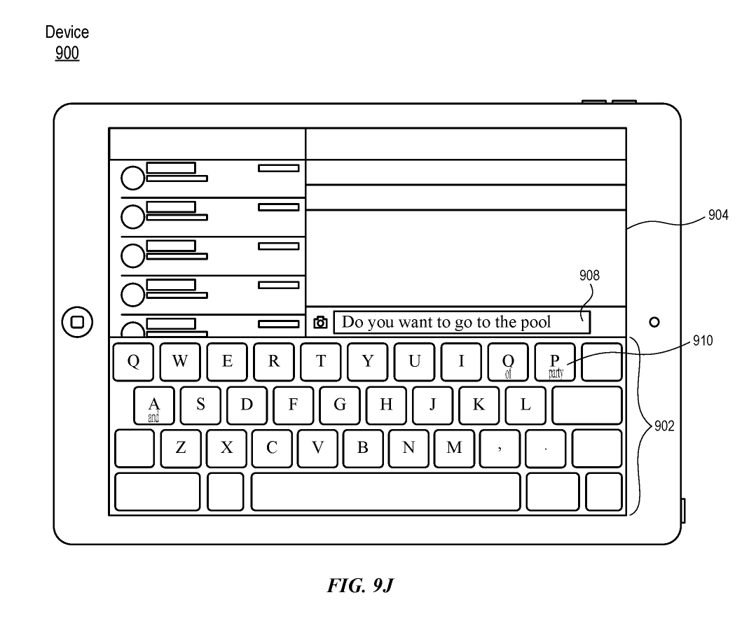

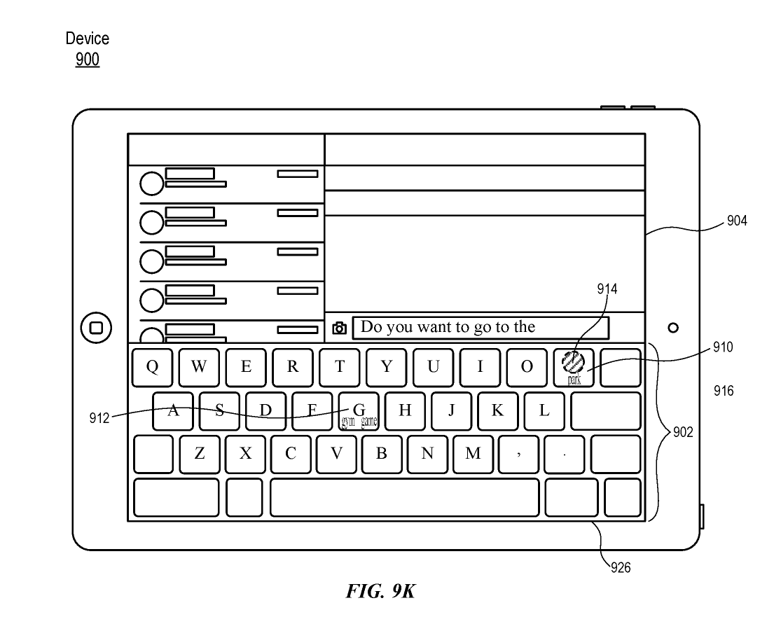

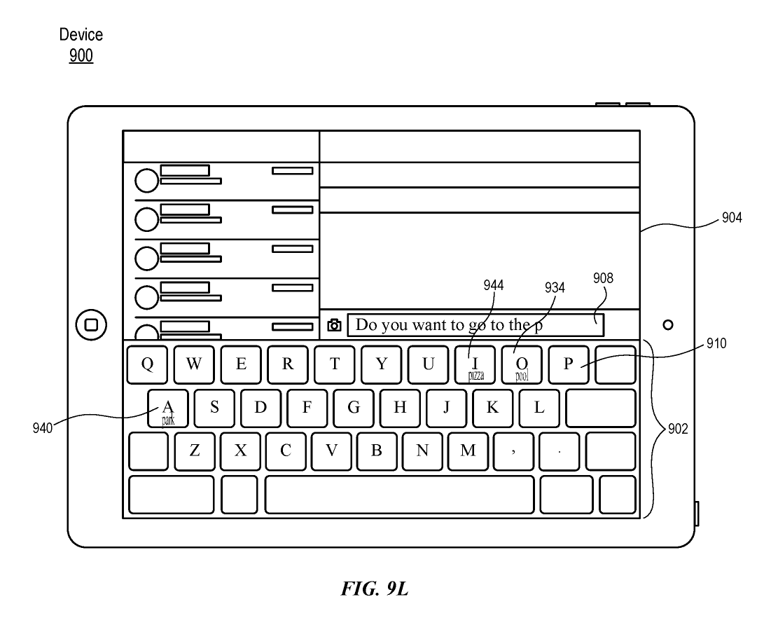

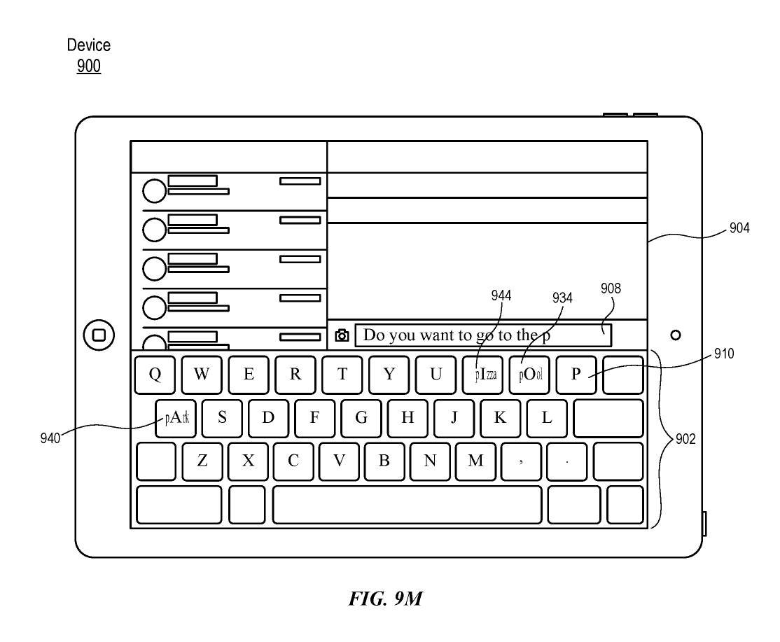

As shown in FIG. 6, text prediction module 600 includes text prediction engine 602, lexicon(s) 606, and language model(s) 608. Lexicon(s) 606 includes one or more collections of words or phrases. For example, lexicon(s) 606 includes a collection of words or phrases that are frequently used by the user. Language model(s) 608 includes one or more statistical language models (e.g., n-gram language models, neural network based language models, etc.). Text prediction module 600 is configured to determine one or more candidate predicted words in accordance with a context, such as the text input already received from the user. In some examples, the context is the start of a new sentence, message, header, paragraph, page, document, or the like. In one such example, the context is a blank text input field (e.g., blank user interface 908 shown in FIG. 9A). In these examples, the context does not include any text input. The one or more candidate predicted words can be applicable to word completion or word correction applications. As shown in FIG. 6, context (e.g., text input) is received by text prediction engine 602. In this example, the context includes text input, which contains one or more words and/or a partial word. Text prediction engine 602 utilizes lexicon(s) 606 and language model(s) 608 to determine a plurality of candidate predicted words given the text input. Additionally, for each candidate predicted word of the plurality of candidate predicted words, a likelihood score is determined using language model(s) 608. The likelihood score of a candidate predicted word represents the likelihood of the candidate predicted word given the text input. In other examples where the context does not include text input (e.g., start of new sentence, message, header, paragraph, page, document, or the like), text prediction engine 602 determines the plurality of candidate predicted words given the context. In these examples, the determined likelihood score of a candidate predicted word represents the likelihood of the candidate predicted word given the context. Text prediction engine 602 outputs the plurality of candidate predicted words and the corresponding likelihood scores.

Text input module 134, in some examples, is configured to receive the plurality of candidate predicted words and the corresponding likelihood scores from text prediction module 600. In particular, text input module 134 ranks the plurality of candidate predicted words using the likelihood scores and selects the N-highest ranked candidate predicted words to display on a keyboard (e.g., physical or soft keyboard), where N is a predetermined number. Text input module 134, in conjunction with touch screen 112, display controller 156, and graphics module 132, displays the N-highest ranked candidate predicted words on respective keys of the keyboard. In response to receiving a user selection of a candidate predicted word on a key of the keyboard, text input module 134 (in conjunction with touch screen 112, display controller 156, contact/motion module 130, and graphics module 132), causes the selected candidate predicted word to be presented in a displayed user interface of the device (e.g., a text field displayed on touchscreen 112 of device 100).

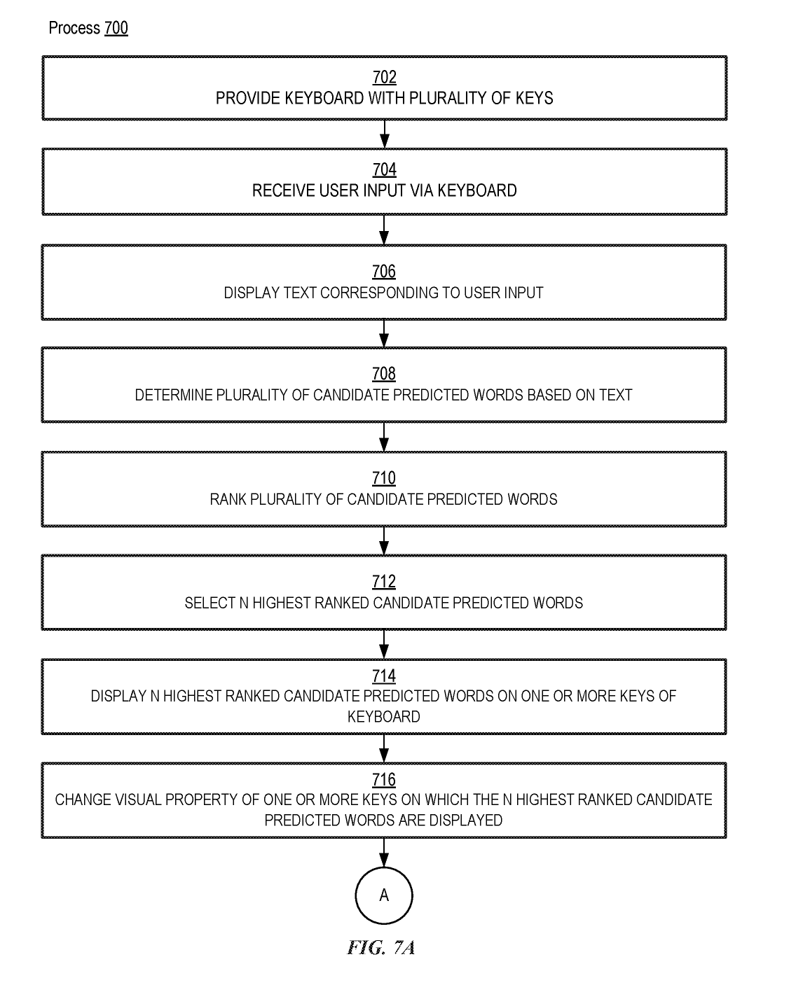

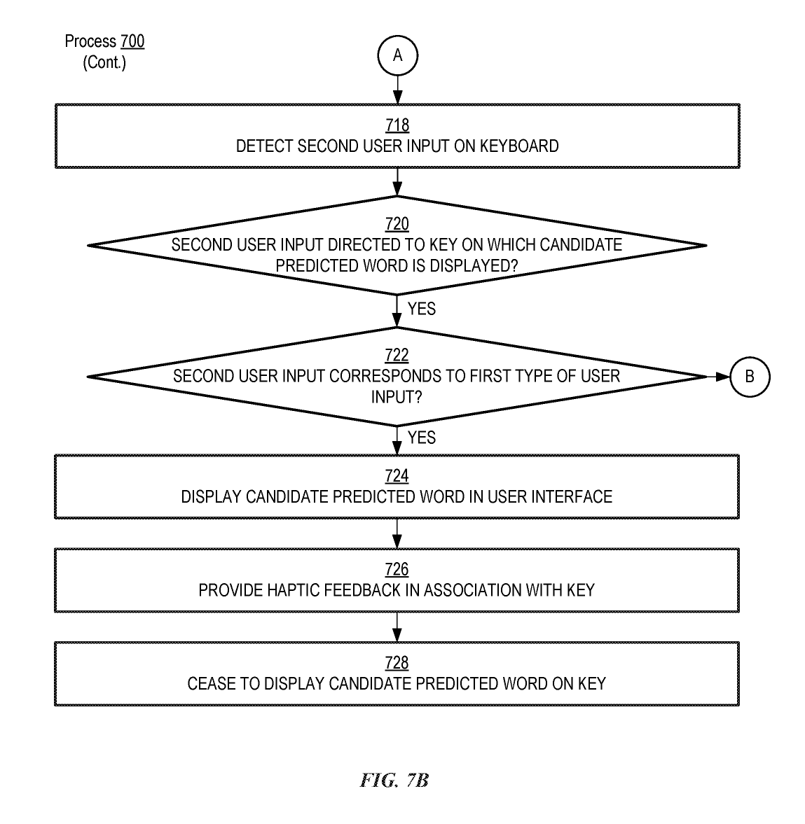

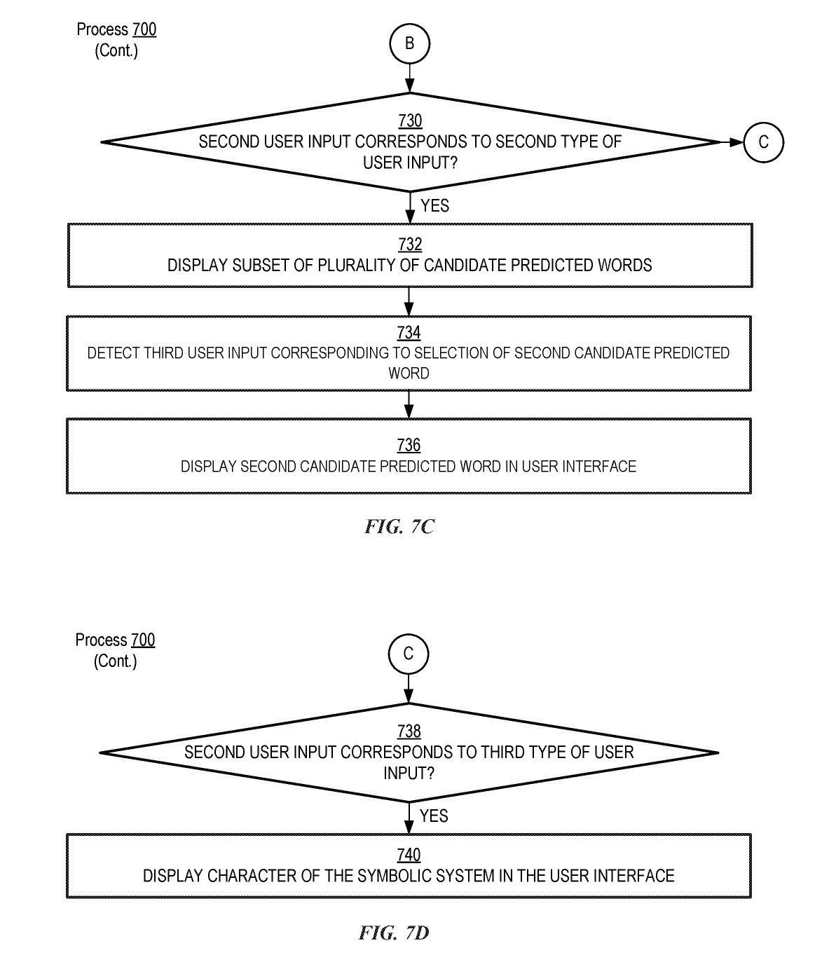

FIGS. 7A-7D illustrate a flow diagram of process 700 for providing text prediction in accordance with some embodiments. FIGS. 9A-9M illustrate electronic device 900 displaying exemplary user interfaces for providing text prediction in accordance with some embodiments. Process 700 is performed using a device (e.g., 100, 300, or 500) with a display. For example, as shown in FIGS. 9A-M, process 700 is performed using device 900. Device 900 is, for example, similar or identical to devices 100, 300, or 500, described above. Process 700 is described below with simultaneous reference to FIGS. 9A-9M. Some operations of process 700 are, optionally, combined, the order of some operations are, optionally, changed, and some operations are, optionally, omitted.

At block 702, a keyboard is provided. In some examples, the keyboard is a soft keyboard (e.g., virtual keyboard) that is displayed on a touchscreen (e.g., touchscreen 112) of the electronic device. In these examples, block 702 is performed using a text input module (e.g., text input module 134) to display the soft keyboard on the touchscreen. For example, as shown in FIG. 9A, soft keyboard 902 is displayed on touchscreen 904 of device 900. Keyboard 902 includes plurality of keys 906, where each key is configured to register a respective character of a symbolic system on displayed user interface 908. For example, key 910 is configured to register the letter “P” of the English alphabet on user interface 908 upon detecting a user selection of key 910. In this example, user interface 908 is a text field displayed on touchscreen 904.

Although, in the present example, keyboard 902 is a soft keyboard displayed on a touchscreen, it should be recognized that other variations of keyboards can be provided and implemented for process 700. Specifically, in some examples, block 702 includes providing a projected keyboard. The projected keyboard comprises a projected image of a virtual keyboard on a surface. In other examples, block 702 includes providing a physical keyboard with a plurality of physical keys. In these examples, each key of the plurality of physical keys is configured to dynamically display text and/or images (e.g., display a candidate predicted word as described in block 714).

At block 704, user input is received (e.g., with text input module 134 and/or contact/motion module 130) via the keyboard. The user input corresponds to text. In some examples, the text includes one or more words. In some examples, the text includes a partial word. With reference to FIG. 9A, user input is received via keyboard 902. In this example, the user input is a series of touch inputs received from the user via keyboard 902. The touch inputs correspond to the text words “Do you want to go to the.”

At block 706, in response to receiving the user input of block 704, the text corresponding to the user input is displayed (e.g., with text input module 134 and/or graphics module 132) in the user interface. For example, as shown in FIG. 9A, in response to receiving the series of touch inputs via keyboard 902, the text words “Do you want to go to the” are displayed in user interface 908 on touchscreen 904.

At block 708, a plurality of candidate predicted words is determined (with text prediction module 600) based on the text. In particular, the determination is made using a language model (e.g., language model(s) 608) and/or a lexicon (e.g., lexicon(s) 606). In some examples, the plurality of candidate predicted words are determined based on one or more words in the text. In some examples, the plurality of candidate predicted words are determined based on a partial word in the text. In the example of FIG. 9A, the plurality of candidate predicted words are determined based on at least some of the words “Do you want to go to the.”

In some examples, the plurality of candidate predicted words is determined based on context other than text input (e.g., text input received at block 706). Specifically, the plurality of candidate predicted words is determined, for example, based on the context of being at the start of a sentence, header, paragraph, page, document, or the like. Other types of context can similarly be used to determine the plurality of candidate predicted words.

At block 710, the plurality of candidate predicted words are ranked (e.g., with text input module 134) using a language model. In particular, using the language model, a likelihood score is determined for each candidate predicted word of the plurality of candidate predicted words. The likelihood score represents the likelihood of the respective candidate predicted word given the text. In examples where context other than text input is used to determine the plurality of candidate predicted words, the likelihood score represents the likelihood of the respective candidate predicted word given the context. The plurality of candidate predicted words are ranked based on the likelihood scores. In particular, candidate predicted words with higher likelihood scores are ranked higher than candidate predicted words with lower likelihood scores.

At block 712, the N highest ranked candidate predicted words of the plurality of candidate predicted words are selected (e.g., with text input module 134), where N is a predetermined number. In the example of FIG. 9A, N is three and thus the three highest ranked candidate predicted words (e.g., “park,” “gym,” and “game”) are selected from the plurality of candidate predicted words. In other examples, N can be any predetermined number.

At block 714, the selected N highest ranked candidate predicted words are displayed (e.g., with text input module 134 and/or graphics module 132) on one or more keys of the keyboards. Each candidate predicted word of the N highest ranked candidate predicted words is displayed on a respective key of the plurality of keys. The key on which a candidate predicted word is displayed corresponds to a character of the symbolic system, where that character is contained in the displayed candidate predicted word. For example, with reference to FIG. 9A, the three highest ranked candidate predicted words “park,” “gym,” and “game” are displayed on respective keys of keyboard 902. As shown, each candidate predicted word begins with a respective character of the symbolic system that corresponds to the respective key on which the candidate predicted word is displayed. Specifically, the candidate predicted word “park” begins with the letter “P” and is thus displayed on key 910, which is configured to register the letter “P” in user interface 908 when selected. Similarly, candidate predicted words “gym” and “game” both begin with the letter “G” and are concurrently displayed on key 912, which is configured to register the letter “G” in user interface 908 when selected.

In some examples, the displayed candidate predicted words are each integrated with the character of the symbolic system that is depicted on the respective key. For example, as shown in FIG. 9B, prior to displaying the candidate predicted words on keys 910 and 912, respective characters of the symbolic system are already depicted on the keys of keyboard 902. Specifically, the letter “P” is depicted on key 910 and the letter “G” is depicted on key 912 prior to displaying the candidate predicted words. In the example of FIG. 9B, the candidate predicted word “park” is displayed on key 910 such that the letter “P” depicted on key 910 is integrated with the candidate predicted word “park” and forms part of the displayed candidate predicted word “park.” Similarly, the candidate predicted words “gym” and “game” are displayed on key 912 such that the letter “G” depicted on key 912 is integrated with the candidate predicted words and forms part of each displayed candidate predicted word “gym” and “game.” Displaying the candidate predicted words “park,” “gym,” and “game” in such an integrated manner can be desirable to intuitively inform the user of the dual input functions of keys 910 and 912, thereby increasing the likelihood that the text prediction functionality will be utilized to improve the speed and efficiency of text input.

Although, in the present example, the N highest ranked candidate predicted words are displayed on one or more keys of the keyboard, it should be recognized that, in other examples, the N highest ranked candidate predicted words can be displayed at least partially outside of the respective keys of the keyboard. For instance, in other examples, the candidate predicted word “park” can be displayed in the region between key 910 and one or more adjacent keys (e.g., “0” key or “L” key). Similarly, the candidate predicted words “gym” and “game” can be displayed in the region between key 912 and one or more adjacent keys (e.g., “V” key, “B” key, “H” key, “F” key, “T” key, or “Y” key).

At block 716, upon displaying a candidate predicted word on a key, a visual property of the key is changed (e.g., with text input module 134 and/or graphics module 132). For example, as shown in FIG. 9B, the size of keys 910 and 912 is increased upon displaying the candidate predicted words “park,” “game,” and “gym.” Additionally or alternatively, the font of the depicted characters “P” and “G” on keys 910 and 912 respectively is changed upon displaying the candidate predicted words. Changes to various other visual properties of keys 910 and 912 can be contemplated. For example, one or more of the color, shading, brightness, or shape of keys 910 and 912 can be changed upon displaying the candidate predicted words. Changing the visual property of the respective key can serve to draw the user's attention toward suggested candidate predicted words generated by the device, thereby increasing the likelihood that the user will select one of the candidate predicted words and improving the productivity of the user.

At block 718, a second user input is detected (e.g., with text input module 134 and/or contact/motion module 130) on the keyboard. For example, the second user input includes an interaction between the keyboard and the user's finger, such as a press, tap, swipe gesture, or the like. In the example shown in FIG. 9C, the second user input comprises a swipe gesture from position 914 to position 916 on keyboard 902. Specifically, detecting the second user input, in this example, includes detecting a contact initiated at position 914, detecting continuation contact while moving from position 914 to position 916, and detecting a release in contact from keyboard 902 at position 916.

At block 720, a determination is made (e.g., with text input module 134 and/or contact/motion module 130) as to whether the second user input is directed to a first key on which a first candidate predicted word is displayed. The first key is configured to register a first character of the symbolic system on the user interface. For example, with reference to FIG. 9C, a determination is made as to whether the second user input is directed to key 910 on which candidate predicted word “park” is displayed. In the present example, where keyboard 902 is a soft keyboard displayed on touchscreen 904, the determination is made by analyzing the position at which the user initially makes contact with keyboard 902. For example, in FIG. 9C, the detected second user input is a swipe gesture comprising an initial contact at position 914. Specifically, position 914 is the center position of the area where contact is initiated by the user with the keyboard. If position 914 is within a predefined area corresponding to key 910, then the second user input is determined to be directed to key 910.

In some examples, the determination of block 720 includes determining a likelihood score representing the likelihood that the second user input is directed to the first key. The likelihood score is determined, for example, based on the distance of position 914 from a reference point of key 910. The reference point of key 910 is, for example, the center of the predefined area corresponding to key 910. The likelihood score is determined to be higher if position 914 is closer to the reference point of key 910 relative to any respective reference point of adjacent keys. Conversely, the likelihood score is determined to be lower if position 914 is farther from the reference point of key 910 relative to any respective reference point of adjacent keys. In some examples, the second user input is determined to be directed to key 910 if the likelihood score is greater than a first predetermined threshold value. Conversely, the second user input is determined not to be directed to key 910 if the likelihood score is lower than a second predetermined threshold value.

In examples where the keyboard is a physical keyboard, the determination of block 720 is based on whether the second user input is detected at a first physical key on which the first candidate predicted word is displayed. In some examples, if the second user input is detected at the first physical key on which the first candidate predicted word is displayed and not on any other physical key of the keyboard, then the second user input is determined to be directed to the first physical key on which the first candidate predicted word is displayed.

At block 722, a determination is made (e.g., with text input module 134 and/or contact/motion module 130) as to whether the second user input corresponds to a first type of user input. The first type of user input is, for example, a predetermined pattern of user input stored on the device prior to receiving the second user input. In some examples, the determination of block 722 includes comparing the second user input to the predetermined pattern of user input. If the second user input is determined to match the predetermined pattern of user input, then the second user input is determined to correspond to the first type of user input.

In some examples, the first type of user input is a long press on the keyboard. Specifically, in these examples, the first type of user input includes contact being initiated with the keyboard at a first position followed by contact being released from the keyboard at the first position, where the duration between the initiating and the releasing of contact is greater than a predetermined duration.

In some examples, the first type of user input is a hard press on the keyboard. Specifically, in these examples, the first type of user input includes contact being initiated with the keyboard at a first position, where the intensity of the contact (e.g., detected by intensity sensors 165) exceeds an intensity threshold.

In some examples, the first type of user input is a double tap gesture. Specifically, in these examples, the first type of user input includes two successive contacts with the keyboard at a first position and within a predetermined duration. The two successive contacts are separated by a release of contact from the keyboard.

In some examples, the first type of user input includes contacting a specific portion of the key. In particular, the first type of user input includes contact being initiated at a predefined region of the key on which the candidate predicted word is displayed followed by contact being released from the predetermined region of the key.

In some examples, the first type of user input is a swipe gesture. Specifically, in these examples, the first type of user input includes contact being initiated with the keyboard at a first position, contact being maintained with the keyboard while moving from the first position to a second position on the keyboard, and contact being released from the keyboard at the second position. The first type of user input requires, in some examples, that the distance between the first position and the second position be greater than a predetermined distance. In other examples, the first type of user input requires a component of the vector representing the swipe gesture from the first position and the second position (e.g., component of the vector representing the swipe gesture from position 914 to position 916 of FIG. 9C, where the component is parallel or perpendicular to reference axis 924 of keyboard 902) to have a distance greater than a predetermined distance.

In examples where the first type of user input is a swipe gesture, a visual property of the first key or the first candidate predicted word displayed on the first key can be changed in response to detecting the continuous contact with the keyboard from the first position to the second position. For example, with reference to FIG. 9D, in response to detecting the continuous contact from position 914 to position 916 and prior to detecting the release of contact at position 916, a visual property of the candidate predicted word “park” on key 914 is changed. In this example, the size of the candidate predicted word “park” is increased. The position of the candidate predicated word is also shifted away from positions 914 and 916. Additionally, in this example, the size of key 914 is increased to accommodate the increase in size of candidate predicted word “park.” The change in the visual property of the displayed first candidate predicted word can be desirable to serve as a feedback mechanism to the user that the first candidate predicted word is being selected.

In examples where the first type of user input is a swipe gesture, the first type of user input can require contacting a region of the first key where the first candidate predicted word is displayed while moving from the first position to the second position. For example, with reference to FIG. 9C, the first type of user input requires that, while the contact input moves from position 914 to position 916, contact is made with a predefined region of key 910 in which the candidate predicted word “park” is displayed. This requirement can be particularly desirable for distinguishing between inputs associated with different candidate predicted words displayed on the same key. For example, with reference to FIG. 9E, the first swipe gesture from position 918 to position 920 is a first type of user input that corresponds to the candidate predicted word “gym,” because the first swipe gesture includes making contact with a predefined region of key 912, in which the candidate predicted word “gym” is displayed. Similarly, in this example, the second swipe gesture from position 918 to position 922 is a first type of user input that corresponds to the candidate predicted word “game,” because the second swipe gesture makes contact with a predefined region of key 912 in which the candidate predicted word “game” is displayed.

Additionally or alternatively, in examples where the first type of user input is a swipe gesture, the first type of user input can require at least a component of the vector representing the swipe gesture to be in a predetermined direction. For example, with reference to FIG. 9C, the first type of user input requires that a component of the vector representing the swipe gesture from position 914 to position 916 be in a direction toward bottom edge 926 of keyboard 902, where the component is parallel to reference axis 924. In another example, with reference to FIG. 9E, different directions of swipe gestures can correspond to different candidate predicted words on the same key. Specifically, the first type of user input that corresponds to the candidate predicted word “gym” can require that a first component of the vector representing the first swipe gesture from position 918 to position 920 be in a first direction toward bottom edge 926 of keyboard 902 and that a second component of the same vector be in a second direction toward left edge 925 of keyboard 902, where the first component and the first direction are parallel to reference axis 924, and where the second component and the second direction are perpendicular to reference axis 924. Similarly, the first type of user input that corresponds to the candidate predicted word “game” can require that a first component of the vector representing the second swipe gesture from position 918 to position 922 be in a first direction toward bottom edge 926 of keyboard 902 and that a second component of the same vector be in a third direction toward right edge 928 of keyboard 902, where the first component and the first direction are parallel to reference axis 924, and where the second component and the third direction are perpendicular to reference axis 924.

In response to determining that the second user input is directed to a first key on which a first candidate predicted word is displayed and that the second user input corresponds to the first type of user input, one or more of blocks 724-728 are performed. Specifically, in some examples, in response to determining that the second user input is directed to a first key on which a first candidate predicted word is displayed and that the second user input corresponds to the first type of user input, one or more of blocks 724-728 are performed automatically, without additional prompting from the device or additional input from the user.

At block 724, the first candidate predicted word is displayed (e.g., with text input module 134 and/or graphics module 132) in the user interface. Specifically, the second user input is registered as a selection of the first candidate predicted word and, in response, the first candidate predicted word is displayed in the user interface. For example, with reference to FIG. 9F, the candidate predicted word “park” is displayed in user interface 908 in response to determining that the second user input (e.g., the swipe gesture from position 914 at position 916 in FIG. 9C) is directed to key 910 and corresponds to the first type of user input.

At block 726, haptic feedback is provided (e.g., with haptic feedback module 133 and using tactile output generator 167). The haptic feedback, in some examples, is provided in association with the first key to which the second user input was directed. For example, in response to determining that the second user input is directed to key 910 and corresponds to the first type of user input, haptic feedback is provided in association with key 910. In some examples, the haptic feedback is directed to the region of keyboard 902 corresponding to key 910. In examples where the keyboard is a physical keyboard, the haptic feedback is provided by a tactile output generator of the respective physical key.

At block 728, the electronic device ceases to display (e.g., with text input module 134 and/or graphics module 132) the first candidate predicted word on the first key. For example, as shown in FIG. 9F, device 900 ceases to display the candidate predicted word “park” on key 910 in response to determining that the second user input is directed to key 910 and corresponds to the first type of user input.

It should be recognized that in response to displaying the first candidate predicted word in the user interface at block 724, the first candidate predicted word can be utilized to perform additional word prediction. For instance, in some examples, process 700 includes repeating any of blocks 708-716 based on the updated text in user interface 908. As shown in the example of FIG. 9F, the text in user interface 908, which now includes the candidate predicted word “park,” can be utilized to perform additional word prediction. Specifically, a second plurality of candidate predicted words are determined based on the text in user interface 908 (block 708) and the N-highest ranked candidate predicted words of the second plurality of candidate predicted words are selected and displayed on respective keys of the keyboard (blocks 710-714). For example, as shown in FIG. 9F, the three highest candidate predicted words “and,” “in,” and “with,” which are determined based on the text “Do you want to go to the park,” are displayed respectively on the “A” key, the “I” key, and the “W” key of keyboard 902. Further, in some examples, one or more of blocks 718-728 are performed after displaying the N-highest ranked candidate predicted words of the second plurality of candidate predicted words to register and display additional words or text in the user interface.

With reference back to block 720 of FIG. 7B, in some examples, the second user input can be ambiguous with respect to whether it is directed to the first key on which the first candidate predicted word is displayed or to an adjacent key. For example, with reference to FIG. 9G, the second user input includes the swipe gesture from position 930 to position 932. As shown, position 930 is between key 910 and key 934. In this example, it is ambiguous as to whether the second user input is directed to key 910 or to key 934. As discussed above, the determination of block 720 includes, in some examples, determining a likelihood score representing the likelihood that the second user input is directed to key 910. If the likelihood score is between the first threshold value and the second threshold value, then the second user input is determined to be ambiguous as to whether it is directed to key 910 or, for example, adjacent key 934. In some examples, the ambiguity can be resolved based on the determination of block 722 and whether a candidate predicted word is displayed on key 934. For example, in response to determining that the second user input is ambiguous with respect to being directed to key 910 or to adjacent key 930 and that the second user input corresponds to the first type of user input, a determination is made as to whether one or more of the plurality of candidate predicted words of block 708 are displayed on key 934. In the present example, there is no candidate predicted word displayed on key 934. In response to determining that one or more of the plurality of candidate predicted words are not displayed on key 934, the likelihood score that the second user input is directed to key 910 is increased. For example, a weighting factor is applied to increase the likelihood score. The increase in the likelihood score is, in some examples, sufficient to resolve the ambiguity such that it is determined at block 720 that the second user input is directed to key 910.

In examples where one or more candidate predicted words are displayed on key 934, the ambiguity can be resolved using a language model. For example, if the likelihood of the candidate predicted word “park” is determined to be greater than the likelihood of any of the candidate predicted words on key 934 given the text in user interface 908, then the likelihood score that the second user input is directed to key 910 is increased to resolve the ambiguity.

With reference again to blocks 720 and 722 of FIG. 7B, in some examples, the second user input is determined to be directed to the first key on which the first candidate predicted word is displayed, but the second user input is determined to not correspond to the first type of user input. In these examples, in response to determining that the second user input is directed to the first key and that the second user input does not correspond to the first type of user input, one or more of blocks 730-736 are performed.

At block 730, a determination is made (e.g., with text input module 134 and/or contact/motion module 130) as to whether the second user input corresponds to a second type of user input. The second type of user input is, for example, a second predetermined pattern of user input stored on the device prior to receiving the second user input. The second type of user input can be any type of user input on the keyboard (e.g., long press, hard press, double tap gesture, swipe gesture, etc.), but is different from the first type of user input. For example, if the first type of user input is a swipe gesture, the second type of user input can be a hard press. With reference to FIG. 9H, the second user input is, for example, a hard press on key 910 at position 914. In this example, it is determined that the second user input (e.g., the hard press) corresponds to the second type of user input. In response to determining that the second user input corresponds to the second type of user input, one or more of blocks 732-734 are performed. Specifically, in response to determining that the second user input corresponds to the second type of user input, one or more of blocks 732-734 are performed, automatically, without additional prompting from the device or additional input from the user.

At block 732, a subset of the plurality of candidate predicted words is displayed (e.g., with text input module 134 and/or graphics module 130) in a region of the keyboard adjacent to the first key. The subset includes one or more candidate predicted words other than the first candidate predicted word. Each candidate predicted word in the subset begins with the first character of the symbolic system. For example, with reference to FIG. 9H, the second user input is directed to key 910 at position 914. In this example, the second user input is a hard press on key 910 at position 914. In response to determining that the second user input corresponds to the second type of user input, user interface 936 is displayed adjacent to key 910. Additionally, candidate predicted words “party,” “pizza,” “pool,” “public,” and “pyramid,” which all begin with the letter “P,” are displayed in user interface 936. In this example, the candidate predicted words that are displayed in user interface 936 are not the three highest ranked candidate predicted words of the plurality of candidate predicted words determined at block 708, but are the next five highest ranked candidate predicted words that begin with the letter “P.” It should be recognized that the number of candidate predicted words displayed in user interface 936 can vary. In some examples, user interface 936 is continuously displayed in response to detecting that contact with keyboard 902 is continuously maintained (e.g., at position 914) upon detecting the hard press. If contact with keyboard 902 is released after detecting the hard press, then device 900 ceases to display user interface 936.

At block 734, a third user input is detected (e.g., with text input module 134 and/or contact/motion module 130) on the keyboard. The third user input is, for example, determined to correspond to a selection of a second candidate predicted word of the displayed subset. For example, with reference to FIG. 9I, the third user input is detect, which includes detecting a continuous contact with keyboard 902 while moving from position 914 to 938 and a release of contact with keyboard 902 at position 938. In this example, position 938 corresponds to the candidate predicted word “pool” and thus the third user input is determined to correspond to the selection of the candidate predicted word “pool.”

At block 736, in response to detecting the third user input of block 734, the second candidate predicted word is displayed (e.g., with text input module 134 and/or graphics module 130) in the user interface. For example, with reference to FIG. 9J, in response to detecting the third user input corresponding to the selection of the candidate predicted word “pool,” the candidate predicted word “pool” is displayed in user interface 908. Block 736 is similar to block 724, except that a different candidate predicted word is displayed in user interface 908. In some examples, detecting the third user input and displaying the candidate predicted word “pool” can be associated with additional actions similar to those described in blocks 726 and 728. For instance, in some examples, haptic feedback is provided in response to detecting the third user input and displaying the second candidate predicted word. In some examples, in response to detecting the third user input, the device ceases to display candidate predicted word “park” on key 910 and ceases to display user interface 936. Additionally, the word “pool” in user interface 908 is used to determine and display subsequent candidate predicted words (e.g., “of,” “party,” “and,” etc.) on keyboard 902. For instance, in some examples, process 700 includes repeating one or more of blocks 708-736 to provide addition text prediction functionalities based on the additional word “pool” in user interface 908.

With reference back to block 730, in some examples, the second user input is determined not to correspond to the second type of user input. In these examples, in response to determining that the second user input does not correspond to the second type of user input, one or more of blocks 738-740 are performed.

At block 738, a determination is made (e.g., with text input module 134 and/or contact/motion module 130) as to whether the second user input corresponds to a third type of user input. The third type of user input is, for example, a third predetermined pattern of user input stored on the device prior to receiving the second user input. The third type of user input is different from the first type of user input and the second type of user input. In some examples, the third type of user input is a short press. Specifically, in these examples, the third type of user input includes contact being initiated with the keyboard at a first position followed by contact being released from the keyboard at the first position, where the duration between the initiating and the releasing of contact is less than a predetermined duration. With reference to FIG. 9K, the second user input is, for example, a short press on key 910 at position 914. In this example, the second user input (e.g., the short press) is determined to correspond to the third type of user input. In response to determining that the second user input corresponds to the third type of user input, block 740 is performed. Specifically, in response to determining that the second user input corresponds to the third type of user input, block 740 is performed automatically, without additional prompting from the device or additional input from the user. In other examples, in response to determining that the second user input does not correspond to the third type of user input, the device forgoes performing block 740.

At block 740, the first character of the symbolic system corresponding to the first key is displayed (e.g., with text input module 134 and/or graphics module 130) in the user interface. For example, as shown in FIG. 9L, the letter “P” corresponding to key 910 is displayed in user interface 908. As shown, the letter “P” is displayed in user interface 908 without displaying the candidate predicted word “park” in user interface 908. Additionally, as shown in FIG. 9L, device 900 ceases to display the candidate predicted word “park” on key 910.

It should be recognized that, upon displaying the first character of the symbolic system in the user interface at block 724, the updated text in user interface 908 (which includes the first character of block 740) can be utilized to perform subsequent word prediction. For instance, in some examples, process 700 includes repeating one or more of blocks 708-740 based on the updated text in user interface 908. As shown in the example of FIG. 9L, a third plurality of candidate predicted words are determined based on the text “Do you want to go to the p” in user interface 908 (block 708). In this example, the third plurality of candidate predicted words are determined based at least in part on the “p” at the end of the text “Do you want to go to the p.” Specifically, the determined third plurality of candidate predicted words each begin with the letter “P.” The three highest ranked candidate predicted words of the third plurality of candidate predicted words are selected and displayed on respective keys of keyboard 902 (blocks 710-714). As shown, the three highest ranked candidate predicted words “park,” “pizza,” and “pool,” are displayed on keys 940, 944, and 934, respectively, on keyboard 902. Keys 940, 944, and 934 are configured to register the letters “A,” “I,” and “O,” respectively, on user interface 908. Notably, the letters that each of keys 940, 944, and 934 are configured to register correspond to the subsequent letters (i.e., the second letters) of the respective candidate predicted words “park,” “pizza,” and “pool.” One of the candidate predicted words “park,” “pizza,” and “pool” can thus be selected for displayed in user interface 908 by directing a user input of the first type to the corresponding key (blocks 718-724).

As discussed above, with reference to block 714, each candidate predicted word can each be displayed such that it is integrated with the character of the symbolic system that is depicted on the respective key. In some examples, the candidate predicted words “park,” “pizza,” and “pool” of FIG. 9L are displayed accordingly on keys 940, 944, and 934. For example, with reference to FIG. 9M, the candidate predicted words “park,” “pizza,” and “pool” are each displayed on keys 940, 944, and 934 such that the candidate predicted words are integrated with letters “A,” “I,” and “O” depicted on the respective keys. Specifically, the letters “A,” “I,” and “O” depicted on keys 940, 944, and 934 form the second letter of the respective candidate predicted words “park” “pizza,” and “pool.”

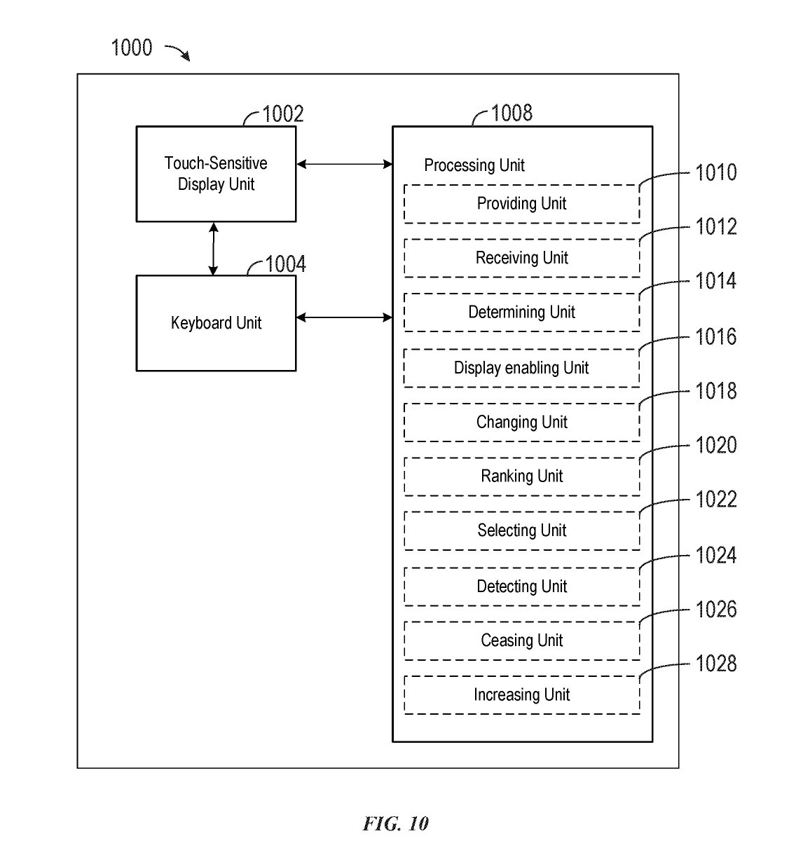

In accordance with some embodiments, FIG. 10 shows an exemplary functional block diagram of an electronic device 1000 configured in accordance with the principles of the various described embodiments. In accordance with some embodiments, the functional blocks of electronic device 1000 are configured to perform the techniques described above. The functional blocks of the device 1000 are, optionally, implemented by hardware, software, or a combination of hardware and software to carry out the principles of the various described examples. It is understood by persons of skill in the art that the functional blocks described in FIG. 10 are, optionally, combined or separated into sub-blocks to implement the principles of the various described examples. Therefore, the description herein optionally supports any possible combination or separation or further definition of the functional blocks described herein.

As shown in FIG. 10, electronic device 1000 includes touch-sensitive display unit 1002 configured to display a graphic user interface (e.g., a soft keyboard) and optionally, keyboard unit 1004 configured to receive user input representing text input. Device 100 further includes processing unit 1008 coupled to touch-sensitive display unit 1002, and optionally, keyboard unit 1004. In some embodiments, the processing unit 1008 includes providing unit 1010, receiving unit 1012, determining unit 1014, display enabling unit 1016, changing unit 1018, ranking unit 1020, selecting unit 1022, detecting unit 1024, ceasing unit 1026, and increasing unit 1028.

In accordance with some embodiments, processing unit 1008 is configured to provide (e.g., with providing unit 1010 and via touch-sensitive display unit 1004) providing a keyboard (e.g., keyboard of block 702) comprising a plurality of keys. Each key of the plurality of keys is configured to register a respective character of a symbolic system on a displayed user interface. Processing unit 1008 is further configured to receive (e.g., with receiving unit 1012), via the keyboard, user input (e.g., user input of block 704) corresponding to one or more words. Processing unit 1008 is further configured to determined (e.g., with determining unit 1014), based on the one or more words, a plurality of candidate predicted words (e.g., the plurality of candidate predicted words of block 708). Processing unit 1008 is further configured to display (e.g., with display enabling unit 1016 and via touch-sensitive display unit 1002 or via keyboard unit 1004) a candidate predicted word of the plurality of candidate predicted words on a key of the plurality of keys, the key configured to register a character of the symbolic system on the user interface, where the candidate predicted word begins with the character of the symbolic system.

In some embodiments, processing unit 1008 is further configured to display (e.g., with display enabling unit 1016 and via touch-sensitive display unit 1002) a second candidate predicted word of the plurality of candidate predicted words on the key, where the second candidate predicted word begins with the character of the symbolic system, and where the second candidate predicted word is displayed concurrently with the candidate predicted word.

In some embodiments, the character of the symbolic system is depicted on the key. The displayed candidate predicted word is integrated with the depicted character on the key such that the depicted character forms part of the displayed candidate predicted word.

In some embodiments, processing unit 1008 is further configured to, upon displaying the candidate predicted word on the key, change (e.g., with changing unit 1018) a visual property (e.g., visual property of block 716) of the key.

In some embodiments, processing unit 1008 is further configured to rank (e.g., with ranking unit 1020) the plurality of candidate predicted words using a language model. Processing unit 1008 is further configured to select (e.g., with selecting unit 1022) N highest ranked candidate predicted words of the plurality of candidate predicted words, where N is a predetermined number. Processing unit 1008 is further configured to display (e.g., with display enabling unit 1016 and via touch-sensitive display unit 1002 or via keyboard unit 1004) each candidate predicted word of the N highest ranked candidate predicted words on a respective key of the plurality of keys, where a beginning character of each candidate predicted word corresponds to a respective character of the symbolic system associated with the respective key.

In some embodiments, processing unit 1008 is further configured to, in response to receiving the user input, display (e.g., with display enabling unit 1016 and via touch-sensitive display unit 1002) the one or more words in the user interface. Processing unit 1008 is further configured to detect (e.g., with detecting unit 1024) a second user input (e.g., second user input of block 718) on the keyboard. Processing unit 1008 is further configured to determine (e.g., with determining unit 1014) whether the second user input is directed to the key. Processing unit 1008 is further configured to determine (e.g., with determining unit 1014) whether the second user input corresponds to a first type of user input (e.g., first type of user input of block 722). Processing unit 1008 is further configured to, in response to determining that the second user input is directed to the key and that the second user input corresponds to the first type of user input, display (e.g., with display enabling unit 1016 and via touch-sensitive display unit 1002) the candidate predicted word in the user interface.

In some embodiments, the first type of user input comprises initiating contact with the keyboard at a first position, maintaining continuous contact with the keyboard while moving from the first position to a second position on the keyboard, and releasing contact from the keyboard at the second position, where a component of a vector representing the moving from the first position to the second position has a distance greater than a predetermined distance.

In some embodiments, the first type of user input comprises, while moving from the first position to the second position, contacting a region of the key where the candidate predicted word is displayed.

In some embodiments, processing unit 1008 is further configured to, in response to detecting the continuous contact with the keyboard from the first position to the second position, change (e.g., with changing unit 1018) a visual property of the displayed candidate predicted word on the key.

In some embodiments, the first type of user input comprises initiating contact with the keyboard at a first position, and releasing contact from the keyboard at the first position, where a duration between the initiating and the releasing is greater than a predetermined duration.

In some embodiments, the first type of user input comprises initiating contact with the keyboard at a first position, where the intensity of the contact exceeds an intensity threshold.

In some embodiments, the first type of user input comprises two successive contacts with the keyboard at a first position and within a predetermined duration, where the two successive contacts are separated by a release of contact from the keyboard.

In some embodiments, the first type of user input comprises initiating contact with a predefined region of the key, and releasing contact with the predefined region of the key.

In some embodiments, processing unit 1008 is further configured to, in response to determining that the second user input is directed to the key and that the second user input corresponds to the first type of user input, cease (e.g., with ceasing unit 1026) to display the candidate predicted word on the key.

In some embodiments, determining whether the second user input is directed to the key includes determining a likelihood score that the second user input is directed to the key. Processing unit 1008 is further configured to, in response to determining that the second user input is ambiguous with respect to being directed to the key or to another key of the plurality of keys and that the second user input corresponds to the first type of user input, determine (e.g., with determining unit 1014) whether one or more of the plurality of candidate predicted words are displayed on the another key. Processing unit 1008 is further configured to, in response to determining that one or more of the plurality of candidate predicted words are not displayed on the another key and, increase (e.g., with increasing unit 1028) the likelihood score that the second user input is directed to the key.

In some embodiments, processing unit 1008 is further configured to, in response to determining that the second user input is directed to the key and that the second user input corresponds to the first type of user input, provide (e.g., with providing unit 1010) haptic feedback (e.g., haptic feedback of block 726) in association with the key.

In some embodiments, processing unit 1008 is further configured to, in response to determining that the second user input is directed to the key and that the second user input does not correspond to the first type of user input, determine (e.g., with determining unit 1014) whether the second user input corresponds to a second type of user input (e.g., second type of user input of block 730). Processing unit 1008 is further configured to, in response to determining that the second user input corresponds to the second type of user input, display (e.g., with display enabling unit 1016 and via touch-sensitive display unit 1002) a subset of the plurality of candidate predicted words (e.g., subset of block 732) in a second region of the keyboard adjacent to the key, the subset including one or more candidate predicted words other than the candidate predicted word. Each candidate predicted word in the subset begins with the character of the symbolic system.

In some embodiments, processing unit 1008 is further configured to, detect (e.g., with detecting unit 1024) a third user input (e.g., third user input of block 734) corresponding to a selection of a third candidate predicted word of the displayed subset. Processing unit 1008 is further configured to, in response to detecting the third user input, display (e.g., with display enabling unit 1016 and via touch-sensitive display unit 1002) the third candidate predicted word in the user interface.

In some embodiments, in response to determining that the second user input is directed to the key and that the second user input does not correspond to the second type of user input, processing unit 1008 is further configured to determine (e.g., with determining unit 1014) whether the second user input corresponds to a third type of user input (e.g., third type of user input of block 738). Processing unit 1008 is further configured to, in response to determining that the second user input corresponds to the third type of user input, display (e.g., with display enabling unit 1016 and via touch-sensitive display unit 1002) the character of the symbolic system in the user interface.

In accordance with some embodiments, processing unit 1008 is configured to provide (e.g., with providing unit 1010 and via touch-sensitive display unit 1004) providing a keyboard (e.g., keyboard of block 702) comprising a plurality of keys. Each key of the plurality of keys is configured to register a respective character of a symbolic system on a displayed user interface. Processing unit 1008 is further configured to receive (e.g., with receiving unit 1012), via the keyboard, user input (e.g., user input of block 704) corresponding to text. Processing unit 1008 is further configured to determined (e.g., with determining unit 1014), based on the text, a plurality of candidate predicted words (e.g., the plurality of candidate predicted words of block 708). Processing unit 1008 is further configured to display (e.g., with display enabling unit 1016 and via touch-sensitive display unit 1002 or via keyboard unit 1004) a candidate predicted word of the plurality of candidate predicted words on a key of the plurality of keys, the key configured to register a character of the symbolic system on the displayed user interface, where at least a portion of the text corresponds to a first portion of the candidate predicted word and a second portion of the candidate predicted word begins with the character of the symbolic system.

In some embodiments, the character of the symbolic system is depicted on the key. The displayed candidate predicted word is integrated with the depicted character on the key such that the depicted character forms part of the displayed candidate predicted word.

In some embodiments, processing unit 1008 is further configured to, upon displaying the candidate predicted word on the key, change (e.g., with changing unit 1018) a visual property of the key.

In some embodiments, processing unit 1008 is further configured to rank (e.g., with ranking unit 1020) the plurality of candidate predicted words using a language model. Processing unit 1008 is further configured to select (e.g., with selecting unit 1022) N highest ranked candidate predicted words of the plurality of candidate predicted words, where N is a predetermined number. Processing unit 1008 is further configured to display (e.g., with display enabling unit 1016 and via touch-sensitive display unit 1002 or via keyboard unit 1004) each candidate predicted word of the N highest ranked candidate predicted words on a respective key of the plurality of keys, where the at least a portion of the text corresponds to a first portion of each candidate predicted word and a beginning character of a second portion of each candidate predicted word corresponds to a respective character of the symbolic system associated with the respective key.

In some embodiments, processing unit 1008 is further configured to, in response to receiving the user input, display (e.g., with display enabling unit 1016 and via touch-sensitive display unit 1002) the text in the user interface. Processing unit 1008 is further configured to detect (e.g., with detecting unit 1024) a second user input (e.g., second user input of block 718) on the keyboard. Processing unit 1008 is further configured to determine (e.g., with determining unit 1014) whether the second user input is directed to the key. Processing unit 1008 is further configured to determine (e.g., with determining unit 1014) whether the second user input corresponds to a first type of user input (e.g., first type of user input of block 722). Processing unit 1008 is further configured to, in response to determining that the second user input is directed to the key and that the second user input corresponds to the first type of user input, display (e.g., with display enabling unit 1016 and via touch-sensitive display unit 1002) the candidate predicted word in the user interface.

In some embodiments, determining whether the second user input is directed to the key includes determining a likelihood score that the second user input is directed to the key. Processing unit 1008 is further configured to, in response to determining that the second user input is ambiguous with respect to being directed to the key or to another key of the plurality of keys and that the second user input corresponds to the first type of user input, determine (e.g., with determining unit 1014) whether one or more of the plurality of candidate predicted words are displayed on the another key. Processing unit 1008 is further configured to, in response to determining that one or more of the plurality of candidate predicted words are not displayed on the another key and, increase (e.g., with increasing unit 1028) the likelihood score that the second user input is directed to the key.

In some embodiments, processing unit 1008 is further configured to, in response to determining that the second user input is directed to the key and that the second user input corresponds to the first type of user input, provide (e.g., with providing unit 1010) haptic feedback (e.g., haptic feedback of block 726) in association with the key.

In some embodiments, processing unit 1008 is further configured to, in response to determining that the second user input is directed to the key and that the second user input does not correspond to the first type of user input, determine (e.g., with determining unit 1014) whether the second user input corresponds to a second type of user input (e.g., second type of user input of block 730). Processing unit 1008 is further configured to, in response to determining that the second user input corresponds to the second type of user input, display (e.g., with display enabling unit 1016 and via touch-sensitive display unit 1002) a subset of the plurality of candidate predicted words (e.g., subset of block 732) in a second region of the keyboard adjacent to the key, the subset including one or more candidate predicted words other than the candidate predicted word, where at least a portion of the text corresponds to a first portion of each candidate predicted word in the subset and a second portion of each candidate predicted word in the subset begins with the character of the symbolic system.

In some embodiments, processing unit 1008 is further configured to, detect (e.g., with detecting unit 1024) a third user input (e.g., third user input of block 734) corresponding to a selection of a third candidate predicted word of the displayed subset. Processing unit 1008 is further configured to, in response to detecting the third user input, display (e.g., with display enabling unit 1016 and via touch-sensitive display unit 1002) the third candidate predicted word in the user interface.

In some embodiments, in response to determining that the second user input is directed to the key and that the second user input does not correspond to the second type of user input, processing unit 1008 is further configured to determine (e.g., with determining unit 1014) whether the second user input corresponds to a third type of user input (e.g., third type of user input of block 738). Processing unit 1008 is further configured to, in response to determining that the second user input corresponds to the third type of user input, display (e.g., with display enabling unit 1016 and via touch-sensitive display unit 1002) the character of the symbolic system in the user interface.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods described herein.

In accordance with some implementations, an electronic device (e.g., a multifunctional device) is provided that comprises means for performing any of the methods described herein.

In accordance with some implementations, an electronic device (e.g., a multifunctional device) is provided that comprises a processing unit configured to perform any of the methods described herein.

In accordance with some implementations, an electronic device (e.g., a multifunctional device) is provided that comprises one or more processors and memory storing one or more programs for execution by the one or more processors, the one or more programs including instructions for performing any of the methods described herein.

The operations described above with reference to FIGS. 7A-D are, optionally, implemented by components depicted in FIGS. 1A-1B, 3, 5A-5B, 6, or FIG. 10. For example, the operations of process 700 can be implemented by one or more of operating system 126, contact/motion module 130, graphics module 132, haptic feedback module 133, text input module 134, applications module 136, text prediction module 600, or processor(s) 120, 310. Similarly, it would be clear to a person having ordinary skill in the art how other processes can be implemented based on the components depicted in FIG. 1A-1B, 3, 5A-5B, or 6.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. An electronic device comprising:
one or more processors; and
memory storing one or more programs, the one or more programs including instructions which, when executed by the one or more processors, cause the one or more processors to:
provide a keyboard comprising a plurality of keys, each key of the plurality of keys configured to register a respective character of a symbolic system on a displayed user interface;
receive, via the keyboard, user input corresponding to text;
determine, based on the text, a plurality of candidate predicted words; and
display a candidate predicted word of the plurality of candidate predicted words on a key of the plurality of keys, the key configured to register a character of the symbolic system on the displayed user interface, wherein at least a portion of the text corresponds to a first portion of the candidate predicted word, and a second portion of the candidate predicted word begins with the character of the symbolic system.

2. The device of claim 1, wherein the instructions further cause the one or more processors to:
display a second candidate predicted word of the plurality of candidate predicted words on the key, wherein the at least a portion of the text corresponds to a first portion of the second candidate predicted word, and a second portion of the second candidate predicted word begins with the character of the symbolic system.

3. The device of claim 1, wherein the character of the symbolic system is depicted on the key, and wherein the displayed candidate predicted word is integrated with the depicted character on the key such that the depicted character forms part of the displayed candidate predicted word.

4. The device of claim 1, wherein the instructions further cause the one or more processors to:
upon displaying the candidate predicted word on the key, change a visual property of the key.

5. The device of claim 1, wherein the instructions further cause the one or more processors to:
rank the plurality of candidate predicted words using a language model;
select, based on the ranking, N highest ranked candidate predicted words of the plurality of candidate predicted words, wherein N is a predetermined number; and
display each candidate predicted word of the N highest ranked candidate predicted words on a respective key of the plurality of keys, wherein the at least a portion of the text corresponds to a first portion of each candidate predicted word, and a beginning character of a second portion of each candidate predicted word corresponds to a respective character of the symbolic system associated with the respective key.

6. The device of claim 1, wherein the instructions further cause the one or more processors to:
in response to receiving the user input, display the text in the user interface;
detect a second user input on the keyboard;
determine whether the second user input is directed to the key;
determine whether the second user input corresponds to a first type of user input; and
in response to determining that the second user input is directed to the key, and that the second user input corresponds to the first type of user input, display the candidate predicted word in the user interface.

7. The device of claim 6, wherein the first type of user input comprises:
initiating contact with the keyboard at a first position;
maintaining continuous contact with the keyboard while moving from the first position to a second position on the keyboard; and
releasing contact from the keyboard at the second position, wherein a component of a vector representing the moving from the first position to the second position has a distance greater than a predetermined distance.

8. The device of claim 7, wherein the first type of user input further comprises:
while moving from the first position to the second position, contacting a region of the key where the candidate predicted word is displayed.

9. The device of claim 7, wherein the instructions further cause the one or more processors to:
in response to detecting the continuous contact with the keyboard from the first position to the second position, change a visual property of the displayed candidate predicted word on the key.

10. The device of claim 6, wherein the first type of user input comprises:
initiating contact with the keyboard at a first position; and
releasing contact from the keyboard at the first position, wherein a duration between the initiating and the releasing is greater than a predetermined duration.

11. The device of claim 6, wherein the first type of user input comprises:
initiating contact with the keyboard at a first position, wherein the intensity of the contact exceeds an intensity threshold.

12. The device of claim 6, wherein the first type of user input comprises:
two successive contacts with the keyboard at a first position and within a predetermined duration, wherein the two successive contacts are separated by a release of contact from the keyboard.

13. The device of claim 6, wherein the first type of user input comprises:
initiating contact with a predefined region of the key; and
releasing contact with the predefined region of the key.

14. The device of claim 6, wherein the instructions further cause the one or more processors to:
in response to determining that the second user input is directed to the key, and that the second user input corresponds to the first type of user input, cease to display the candidate predicted word on the key.

15. The device of claim 6, wherein determining whether the second user input is directed to the key includes determining a likelihood score that the second user input is directed to the key, and wherein the instructions further cause the one or more processors to:
in response to determining that the second user input is ambiguous with respect to being directed to the key or to another key of the plurality of keys, and that the second user input corresponds to the first type of user input:
determine whether one or more of the plurality of candidate predicted words are displayed on the another key; and
in response to determining that one or more of the plurality of candidate predicted words are not displayed on the another key, increase the likelihood score that the second user input is directed to the key.

16. The device of claim 6, wherein the instructions further cause the one or more processors to:
in response to determining that the second user input is directed to the key, and that the second user input corresponds to the first type of user input, provide haptic feedback in association with the key.

17. The device of claim 6, wherein the instructions further cause the one or more processors to:
in response to determining that the second user input is directed to the key, and that the second user input does not correspond to the first type of user input:
determine whether the second user input corresponds to a second type of user input; and
in response to determining that the second user input corresponds to the second type of user input, display a subset of the plurality of candidate predicted words in a second region of the keyboard adjacent to the key, the subset including one or more candidate predicted words other than the candidate predicted word, and wherein the at least a portion of the text corresponds to a first portion of each candidate predicted word in the subset and a second portion of each candidate predicted word in the subset begins with the character of the symbolic system.

18. The device of claim 17, wherein the instructions further cause the one or more processors to:
detect a third user input corresponding to a selection of a third candidate predicted word of the displayed subset; and
in response to detecting the third user input, display the third candidate predicted word in the user interface.

19. The device of claim 17, wherein the instructions further cause the one or more processors to:
in response to determining that the second user input is directed to the key, and that the second user input does not correspond to the second type of user input:
determine whether the second user input corresponds to a third type of user input; and
in response to determining that the second user input corresponds to the third type of user input, display the character of the symbolic system in the user interface.

20. A non-transitory computer-readable storage medium storing one or more programs, the one or more programs comprising instructions which, when executed by one or more processors, cause the one or more processors to:
provide a keyboard comprising a plurality of keys, each key of the plurality of keys configured to register a respective character of a symbolic system on a displayed user interface;
receive, via the keyboard, user input corresponding to text;
determine, based on the text, a plurality of candidate predicted words; and
display a candidate predicted word of the plurality of candidate predicted words on a key of the plurality of keys, the key configured to register a character of the symbolic system on the displayed user interface, wherein at least a portion of the text corresponds to a first portion of the candidate predicted word, and a second portion of the candidate predicted word begins with the character of the symbolic system.

21. A method for providing text prediction during text input, the method comprising:
at an electronic device with a processor and memory:
providing a keyboard comprising a plurality of keys, each key of the plurality of keys configured to register a respective character of a symbolic system on a displayed user interface;
receiving, via the keyboard, user input corresponding to text;
determining, based on the text, a plurality of candidate predicted words; and
displaying a candidate predicted word of the plurality of candidate predicted words on a key of the plurality of keys, the key configured to register a character of the symbolic system on the displayed user interface, wherein at least a portion of the text corresponds to a first portion of the candidate predicted word, and a second portion of the candidate predicted word begins with the character of the symbolic system.
